(19) United States
(12) Patent Application Publication
(10) Pub. No.: US 2016/0042654 A1
(43) Pub. Date: Feb. 11, 2016

(54) METHODS FOR ONLINE EDUCATION

(71) Applicant: Ethan Fieldman, Gainesville, FL (US)

(72) Inventor: Ethan Fieldman, Gainesville, FL (US)

(21) Appl. No.: 14/657,038

(22) Filed: Mar. 13, 2015

Related U.S. Application Data
(60) Provisional application No. 61/954,419, filed on Mar. 17, 2014.

(51) Int. Cl. G09B 7/00; G09B 5/06

(52) U.S. Cl. CPC G09B 7/00; G09B 5/06

(57) ABSTRACT

The present invention is generally directed to a variety of tools, programs and methods for presenting or enhancing an online learning environment for a student viewing or participating in an online learning session. One embodiment is directed to a method of matching instructors and students by utilizing commonalities (or lack thereof) with a social media site and by having the student take a personality test to determine how the student learns most efficiently. Another embodiment is directed to a method of certifying instructors that want to teach an online course. And yet another embodiment is directed to a method presenting an online learning session to students using and toggling between varieties of viewing formats.

### PRIORITY CLAIM AND CROSS-REFERENCE TO RELATED APPLICATIONS

This application claims priority to U.S. Provisional Patent Application Ser. No. 61/954,419 filed Mar. 17, 2014; this application is also a continuation of and claims priority to U.S. patent application Ser. No. 14/216,688 filed Mar. 17, 2014, which claims priority to U.S. Provisional Patent Application Ser. No. 61/799,332 filed Mar. 15, 2013. Each of the foregoing applications are hereby incorporated by reference as if fully set forth herein.

### FIELD OF THE INVENTION

The present invention generally relates to an online education program in which a student may selectively choose an instructor (e.g., teacher or tutor) based on a variety of factors, and additionally an online education program that provides a variety of interactive learning methods between the student(s) and the instructor.

### BACKGROUND

Online learning has grown dramatically in the recent decade with advances in computational speed and advances in media transmission. In an algebra class for example, a conventional learning technique for students who were not present in a classroom was watching videos or digital video discs (DVDs) showing an instructor teaching the subject matter. While a student could watch the video at his or her own pace, there was little to no interaction between the student and the instruction during the real-time teaching of the subject matter. While online learning has become more mainstream, there are still a variety of drawbacks with how and when a student may interact with an instructor, how a student may select an instructor that is a “best-fit” for the student, and a variety of other problems.

### BRIEF SUMMARY OF THE INVENTION

The present invention is generally directed toward an online education program aimed at helping students with a variety of courses, test preparations, and end-of-course (EOC) exams such as, but not limited to Algebra. Last year, fifty-percent (50%) of high school students who took Florida's Algebra 1 EOC failed. In high needs schools, the results were even more alarming—over eighty-percent (80%) of students did not pass the test. In response, embodiments of the present invention allow for partnerships between a learning institution and a vendor that provides ongoing collaboration among teachers, professors, administrators, parents, and students.

In one embodiment, the vendor or the learning institution themselves may provide the learning institution with videos that break down selected problems and provide a corresponding study guide so students can follow along at their own pace. The videos may prompt students to pause and try out problems independently. The videos may also encourage collaboration by asking higher order questions that students can then answer on a virtual wall (e.g., post).

The online education program provides one system with access to all features simultaneously. The user can pause a video and ask a question on wall in real-time, instead of waiting to get an answer the next day in class, from their teacher. Or instead of waiting to see if the instructor covers the material later. The key is there there's a community with immediate feedback from peers and tutors.

Learning does not happen in a vacuum. The best use of technology breaks down barriers and classroom walls. Students, teachers, and parents are no longer confined to the hours of a school day or the constraints of physical location. Students can ask questions on their computers and/or smartphones, and will receive answers from instructors such as, but not limited to, professors, teachers, peers, tutors and other teaching aides. In one embodiment, activities and questions from students may be monitored in real time, and instructors may choose to receive a report of their student's questions and answers. By way of example, the vendor's interactive wall may mimic a social media site such as FACEBOOK® because many of today's students are already familiar and comfortable with one or more social media environments.

In one aspect of the present invention, a method for matching instructors and students includes the steps of (1) generating a database of instructors from one or more learning institutions; (2) determining whether an instructor is friends with or has mutual friends with a student; (3) providing a personality test to the student to determine a learning type of the student; and (4) permitting the student to select an instructor.

In another aspect of the invention, a method for instructor certification from a learning institution includes the steps of (1) receiving a request for a new certification from an instructor; (2) evaluating the request for the new certification; and (3) determining whether the request should be accepted or rejected.

In yet another aspect of the invention, a method for instructor certification from a learning institution includes the steps of (1) receiving a request for a certification from an instructor, wherein the instructor believes that the instructor is pre-certified; (2) verifying the request for the certification; and (3) determining whether the request should be accepted or rejected.

In still yet another aspect of the invention, a method for viewing an online learning session includes the steps of (1) commencing an online learning session in which an instructor is initially viewable by the students through a face camera; (2) toggling a viewing format of the online learning session to a picture-in-picture (PIP) viewing format; and (3) depending on subject being taught by the instructor, selectively toggling the viewing format between the PIP viewing format, the face camera viewing format, and a document camera viewing format.

### BRIEF DESCRIPTION OF THE DRAWINGS

Preferred and alternative embodiments of the present invention are described in detail below with reference to the following drawings:

FIG. 1 is a schematic system diagram showing a computing system usable to carry out various other actions or methods in accordance with the present invention;

FIG. 2 is flow diagram of a method for matching instructors and students according to an embodiment of the present invention;

FIG. 3 is a flow diagram of a method for instructor certification according to an embodiment of the present invention;

FIG. 4 is a flow diagram of a method searching a database having instructor-created course codes according to an embodiment of the present invention;

FIG. 5A is a method for viewing an online learning session according to an embodiment of the present invention;

FIG. 5B is a perspective view of a learning session as seen by a student according to an embodiment of the present invention;

FIG. 5C is a perspective view of another learning session as seen by a student according to an embodiment of the present invention;

FIG. 6 shows a stylus according to an embodiment of the present invention;

FIG. 7 shows a dot created by the stylus of FIG. 6 according to an embodiment of the present invention; and

FIGS. 8-31 are yet further illustrations of the present invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known systems and methods associated with online education programs, modules and learning techniques may not necessarily be shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

In addition, throughout the specification and claims which follow, the word “instructor” is meant as a broad term that includes a variety of people who may teach a particular subject matter, a tutor that assist a student with learning a particular subject matter or any other person that may assist in instructing, teaching or tutoring. Likewise, the word “student” is meant as a broad term that includes potential students, tutees, and any other persons that may desire to learn about a particular subject matter. The term “learning institution” is meant as a broad term that includes any company, college, university, community college, technical school, high school, or any entity involved in providing subject matter for the purposes of education.

The headings provided herein are for convenience only and do not interpret the scope or meaning of the claimed invention

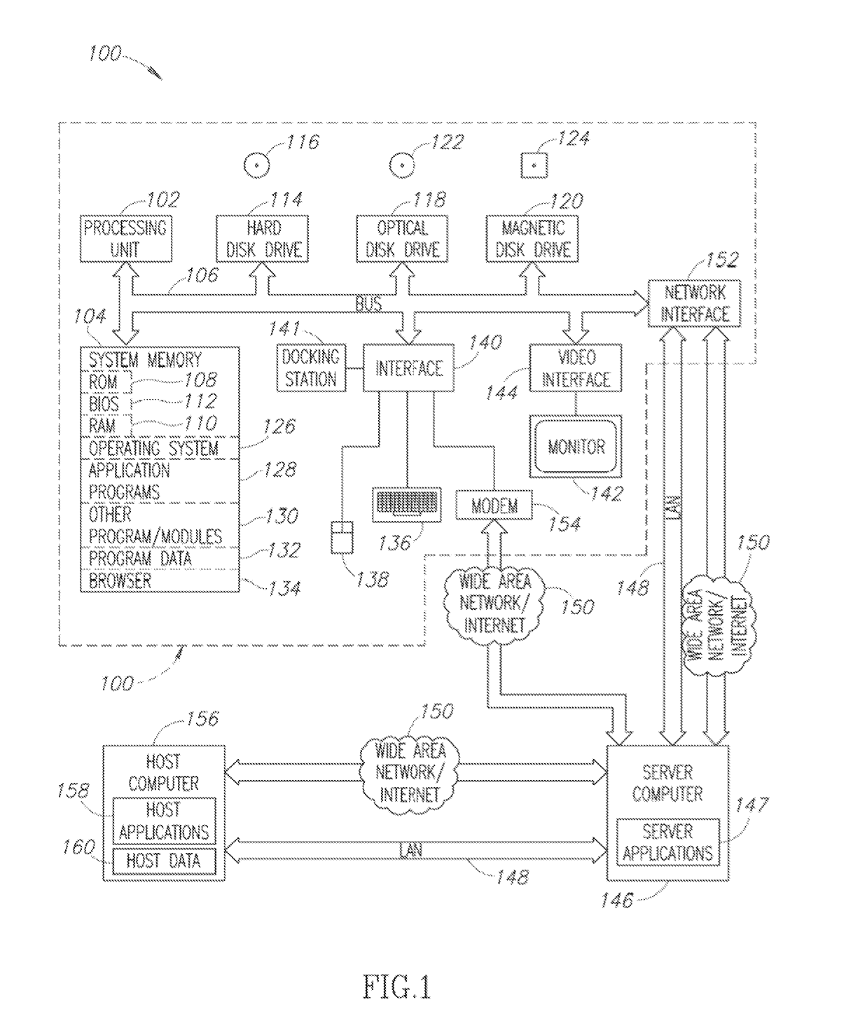

FIG. 1 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The application programs 128, program or modules 130, and program data 132 may include information, instructions and parameters for creating, manipulating, scoring, ranking, uploading, and processing information to determine a best-fit match between students and instructors, to determine a certification of a tutor, provide filtering by a course code, content protection and dissemination restrictions, etc. The system memory 104 may also include a browser 134 for permitting the computer 100 to access and exchange data with sources such as web sites of the Internet, corporate intranets, or other networks as described below, as well as other server applications on server computers such as those further discussed below. In one embodiment, the browser 134 may be used to access course materials, view a tutor, and share information (e.g., questions or comments) with a tutor or otherwise build-up databases of information that may be customizably utilized for a variety of purposes in a learning environment as will be described in greater detail below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 100 as a personal computer, in other embodiments, the computer is some other computer-related device such as a tablet, a television, a personal data assistant (PDA), a cell phone (or other mobile devices).

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. Another interface device that may be coupled to the bus 106 is a docking station 141 configured to receivably and electronically engage a digital pen or stylus for the purpose of data transmission, charging, etc. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

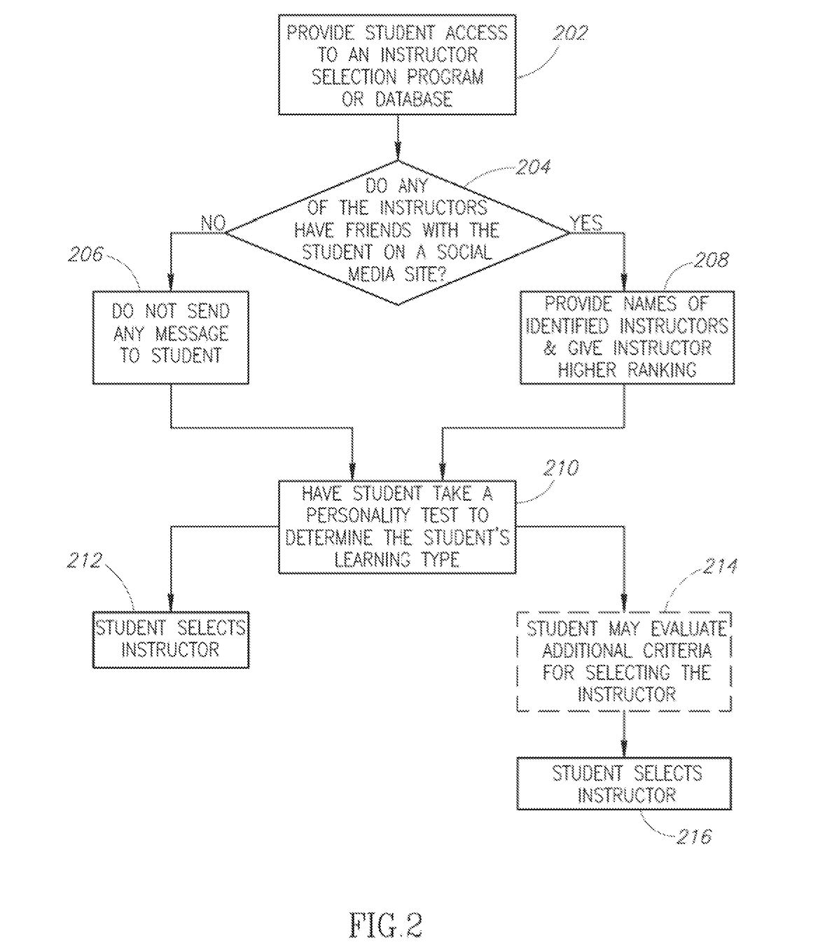

FIG. 2 shows a tutor matching method 200 for matching students or potential students with instructors according to an embodiment of the present invention. For purposes of brevity and clarity herein, a student will be referred to as tutee and an instructor will be referred to as a tutor. Preferably, the purpose of the tutor matching method 200 is to find a best-fit or even an optimal match between a student and an instructor (e.g., a tutor) as quickly as possible. In one embodiment, tutors that are a better match for the tutee are ranked higher in the student's search results. In addition, the tutors may be scored relative to each other using a “matching score.”

At Step 202, tutees are provided access to a tutor selection program and/or database for a particular learning institution or among a variety of tutee selected learning institutions. At Step 204, a program or application determines whether any of the tutors are friends with the tutee on a social media site or have mutual friends or mutual interests in common with the tutee on a social media site. In one embodiment, the social media site may take the form of a FACEBOOK® social media site. If the tutee and tutor are not friends and/or if they do not have any friends in common, then at Step 206 the matching method 200 does not preferably inform the tutee, meaning that the matching method 200 may optionally not return any results to the tutee (i.e., the matching method 200 does not provide anything ominous like “no mutual friends”). In another embodiment, the matching method 200 may return a result to the tutee indicating that no mutual friend matches were found.

If the tutee and tutor are friends and/or if they do have any friends in common, then at Step 208 the matching method 200 will provide those tutors' names to the tutee and will also give such tutors a higher ranking. In one embodiment, Step 208 may also provide the tutee with the ability to see images, profiles or bios of the tutee or tutees that share mutual friends with the tutee. Advantageously, Step 208 introduces a social element to the tutor matching method 200 to help the tutee feel more secure. Finding tutors is primarily based on academic credentials (e.g., I've been teaching Biology for five years). The tutor matching method 200 introduces a social element because peers often have similar interests (e.g., similar majors) and preferences/constraints (e.g., learning styles, schedules), and such peers often do or are able to recommend tutors. The tutor matching method 200 creates an easy way to see who has hired tutors previously, and better gauge of if tutor would be suitable than a conventional star system or “references available upon request.” The tutor matching method 200 may also provide a synthesis of academic information with social information (e.g., liking specific academic subjects, etc.). In one embodiment, a learning environment mimics a social media site to encourage social behavior within academics. Tutees may advantageously find studying more enjoyable and stay engaged longer, which results in better learning outcomes.

The tutor matching method 200 may or may not give the instructor a higher ranking based on having mutual friends. One purpose of identifying mutual friends and notifying the tutee of such is so the tutee may feel safer that they have friends who know the instructor and the tutee can message the mutual friend to check on quality.

At Step 210, the tutee may be given a personality test or quiz to determine the tutee's type of learning style. In one embodiment, the tutee is given a quasi-Meyers-Briggs or other type of personality test that has been customized to determine whether the tutee is a bottom-up or top-down learner (i.e., whether the tutee learns better by having examples first or by having concepts first, respectively). Knowing the learning type of the tutee may factor into the ranking or score of the tutor depending on whether the tutor prefers to provide examples first or concepts first in a teaching environment. The instructor may be given the results of the student's learning style quiz, so the instructor may adapt how they are teaching to best accommodate the learning style of the student.

Based on the ranking of the tutor at this point, at Step 212 the tutee may select a tutor. Alternatively and at Step 214, the tutee may choose to evaluate additional criteria before selecting a tutor. Additional criteria that may be evaluated by the tutor matching method 200 are criteria such as, but not limited to, a tutor's ratings from previous classes or sessions, the tutor's school (e.g., whether the tutor's learning institution is ranked higher by an independent or objective ranking system as compared to another tutor's learning institution or as compared to the tutee's learning institution), the tutor's total hours or years of teaching experience (e.g., higher is better). Additionally or alternatively, other types of criteria may take the form of a certification or certifications from the tutor's learning institution, social data from one or more social media sites, and a session rating history.

The tutor matching method 200 may use the various criteria mentioned above to provide a ranking or scoring for a plurality of tutors. At step 216, the tutee may select a tutor based on the ranking or scoring result provide by the tutor matching method 200. The steps described herein may be re-arranged in a different order and/or some steps may be removed. For example, if the student matches well on personality with the instructor then it might not matter if the student and instructor have mutual. In another example, the student does not necessarily have to see if they have mutual friends or not, and the student may not necessarily take personality test. By way of example, the student may want the instructor with the highest score or rank, which may be determined using a combination of price, quality reviews/ratings, and the personality test as well as other factors. The student may select an instructor or merely message a bunch of the highest rated instructors to gather more information and then make a selection later.

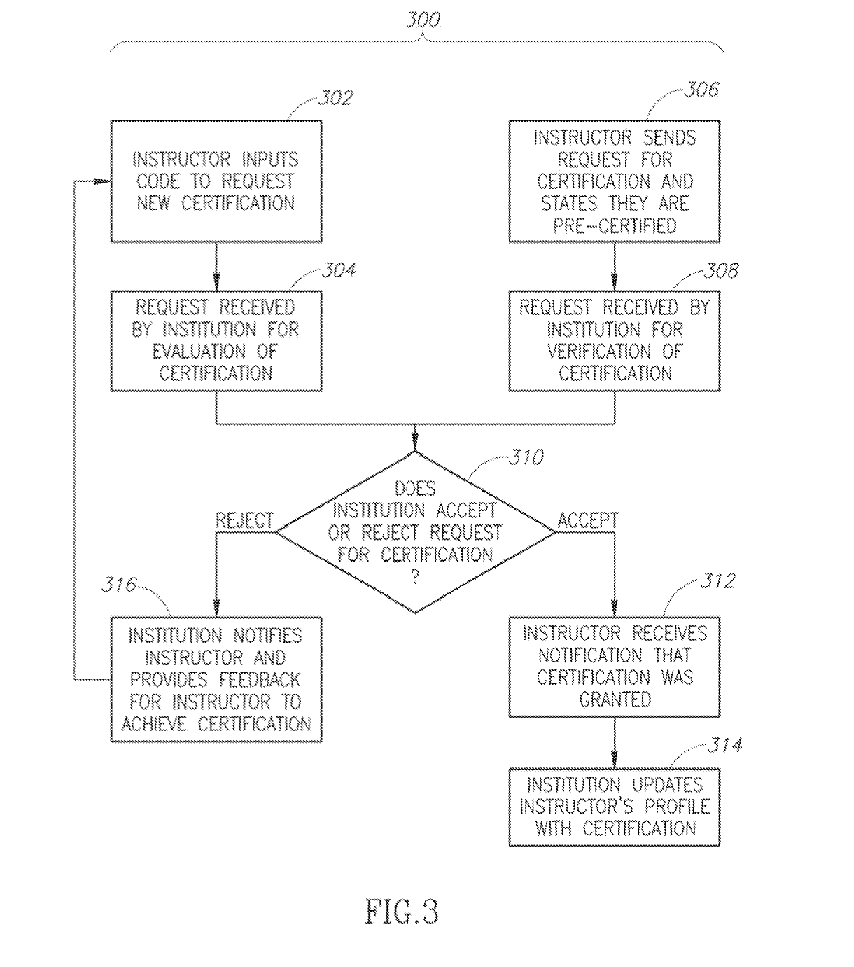

FIG. 3 shows a diagram for an instructor certification method 300 according to an embodiment of the present invention. For a new instructor certification request, at Step 302 an instructor inputs and transmits a code to request a new certification from a learning institution. At Step 304, the request is received by the learning institution for evaluating whether the new instructor certification should be granted. For the situation where the instructor believes that he or she is pre-certified in a particular subject matter area, at Step 306 the instructor sends a request for certification to the learning institution with a statement as to how the instruction is already certified (i.e., pre-certified) in a particular subject matter area. At Step 308, the request is received by the learning institution for verifying whether the pre-certification request should be granted. At least one purpose of an instructor certification process is to indicate quality to students or potential students. Another purpose may be to permit people looking for instructors to use the certifications as a filtering mechanism to see only instructors that are certified in particular subject areas.

At Step 310, the learning institution may accept or reject the request or requests for either new or pre-certified certification. If the learning institution accepts the request, then the instruction receives a notification from the learning institution that the requested certification has been granted. At Step 314, the learning institution may optionally update the instructor's profile or bio, or have the instructor do so, to digitally show that the instructor has been granted the certification. In one embodiment, the digital certification may take the form of a digital badge or other type of graphic that is placed on the instructor's profile and the instructor's certification in the particular subject matter area may be updated in a database operated by the learning institution. By way of example, the granted certification may appear as a digital badge on the instructor's profile alongside their name so that the badge appears when students are searching for an instructor or others are merely viewing marketplace search results.

If the certification request is denied or rejected, at Step 316 the learning institution may notify the requesting instructor and provide feedback for how the instructor may achieve certification. For example, the instructor may need more teaching hours or may need to update their teaching hours. Once the instructor receives such feedback, the instructor may initiate another new certification request at Step 302.

The learning institution may be provided a web portal that shows a list of tutors who have requested certification from that institution, and also show relevant information such as name, time of request, signup date, and a link to profile. In one embodiment, the web portal may be accessed securely. In another embodiment, the web portal may be accessed by the public. One advantage of such a web portal is that it minimizes the time needed by the staff of the learning institution when trying to certify multiple tutors.

In another embodiment, the learning institution may review all the new instructors that have signed up and then decide if the instructor deserves to be certified. Accordingly, the certification process may be initiated by the learning institution instead of the instructor. In yet another embodiment, the instructor may receive certification by obtaining training from the learning institution. Upon completion of the requisite training, the learning institution provides the new instructor a code which other instructors would not know, and then the instructor puts that code into an online education system, which in turn would authorize the certification.

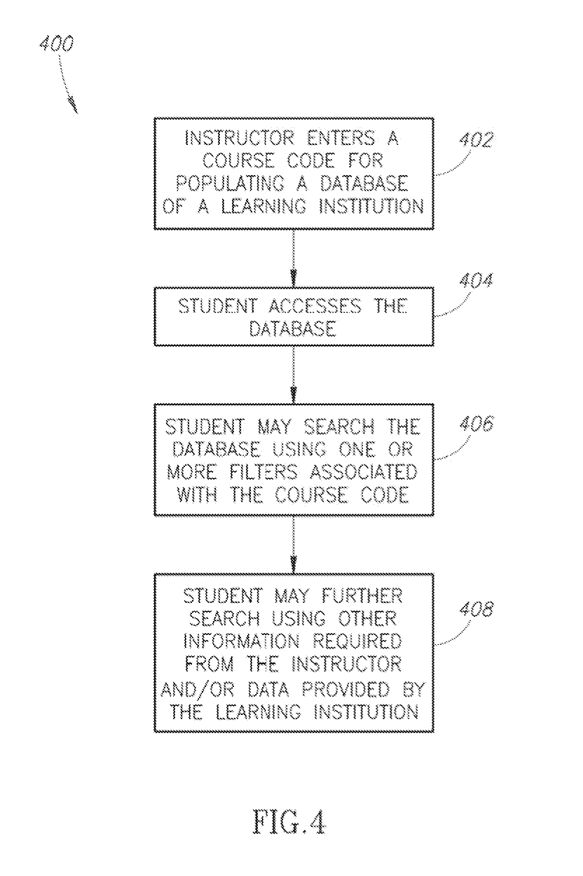

FIG. 4 shows a search method 400 that enables a student to search a course selection database of a learning institution based on one or more course codes provided by an instructor according to an embodiment of the present invention. At Step 402, the instructor enters a course code to populate or further populate the course selection database of the learning institution. By way of example, the course code may be appended with a shortened name for a course taught by the instructor. Generating such a database with the course codes may advantageously provide a faster way of populating the database as compared to a conventional method of populating a course selection database with a list of courses named by the learning institution because in many cases the course names may not be intuitively recognized by a student, especially by beginning or potential students.

At Step 404, one or more students may access or be given access to the course selection database. At Step 406, the student may search the database using one or more filters. At Step 408, the student may optionally utilize additional filters to search for courses using information such as, but not limited to information required from the instructor by the learning institution and course specific data provided by the learning institution (e.g., an instructor's certifications).

In another embodiment, the filters may not be associated with a course code. A course code is like ECON1100, a freshman economics course. The instructors input all the course codes in which they are qualified to teach, which populates a course code database. The student may search or filter the database by typing in the course code they are enrolled in or wish to enroll in. If a student is taking ECON1100, they can type that in and find the instructors that have inputted ECON1100 as one of the instructor's courses. This may eliminate the task of pre-loading all the course codes for every learning institution. Instead, the instructors add course codes as they sign up, and that builds the course code database. Additionally or alternatively, students may search for courses by a course name instead of using the course code.

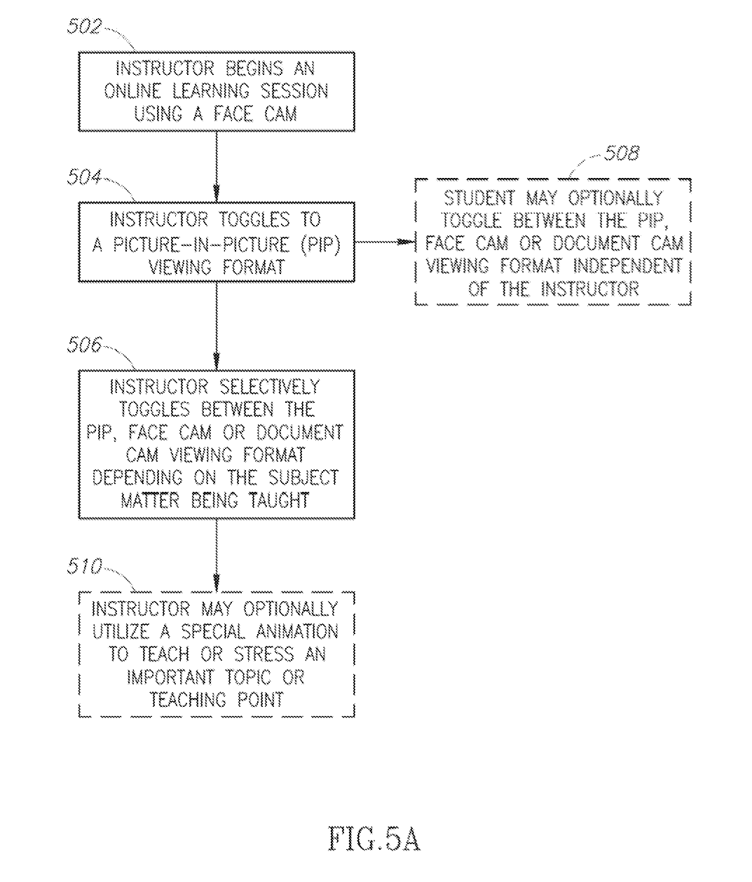

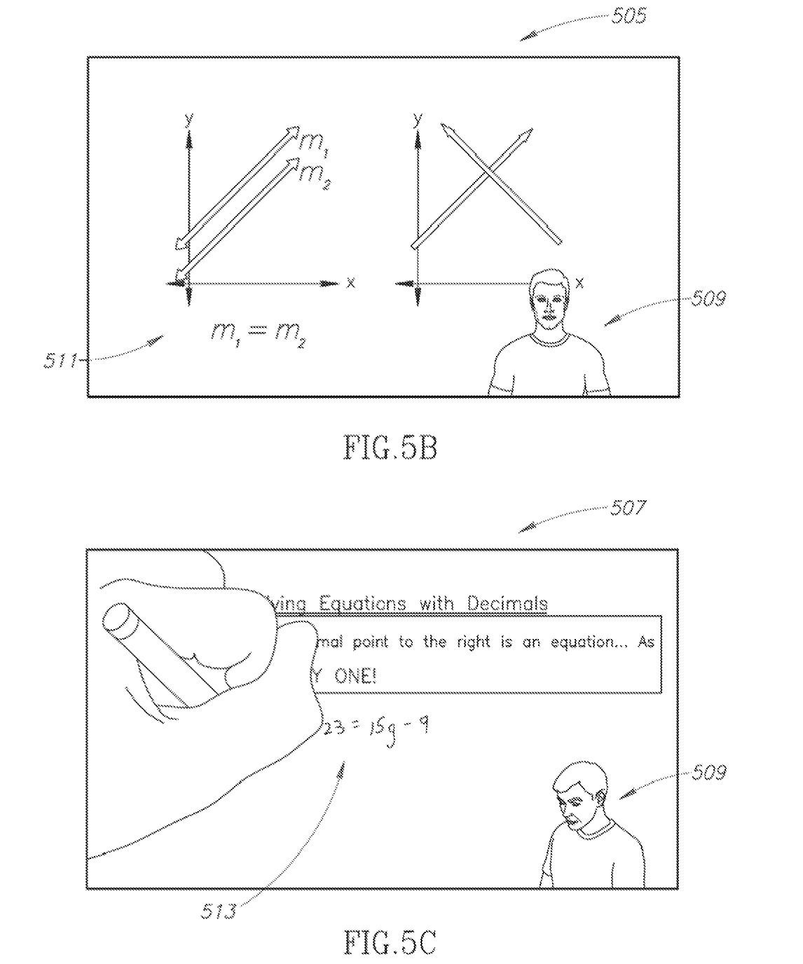

FIG. 5A shows a picture-in-picture (PIP) method 500 for improved interaction between a student and an instructor in an online educational or learning environment according to an embodiment of the present invention. The PIP method 500 allows the student to see the face and impression of the instructor while simultaneously allowing the student to see the content of the subject matter being taught. At Step 502, the instructor begins an online learning session using a face cam, which may take the form of a camera that shows at least the face of the instructor, but may show more of him or her depending on a setup of the camera and a distance from the camera to the instructor. A recording session may be done by a single person with no post editing. Instructors may adjust camera height and/or may use a special mixer to control different shots (face cam, animations, transitions, etc.) with one hand while continually filming so there is no need for post editing.

At Step 504 and after the instructor has introduced the subject matter to be taught in the session, the instructor toggles to the PIP viewing (i.e., from the student's perspective) format. FIGS. 5B and 5C show two embodiments of the PIP viewing format 505, 507, respectively. The instructor 509 is shown in a bottom right portion of the PIP viewing formats 505, 507 and the subject matter, 511, 513, respectively, is shown behind the instructor. At Step 506, the instructor selectively toggles between the PIP view format, a face cam viewing format (i.e., shows the instructor only without any subject matter or documents), or a document viewing format (i.e., showing subject matter or one or more documents without showing the instructor). Optionally at Step 508, the student may toggle between the PIP viewing format, the face cam viewing format or the document viewing format independent of the instructor. At Step 510, the instructor may optionally utilize a special animation to teach or stress one or more important topics, concepts or points of the subject matter being taught. In one embodiment, the special animation is shown in the PIP format. In one embodiment, a document camera's video feed is placed on a green screen behind the instructor, electronically. FIG. 5B shows the instructor looking at a camera (face cam) and then a document camera behind hung from the ceiling (‘doc cam’) and then a green screen behind the instructor. Moreover, the instructor may end a teaching lesson on the face cam to provide a summary of lesson.

Allowing the instructor to change the camera angle may permit or shift the student's focus. If the instructor goes to the face cam, the student should focus on listening to the instructor explain something, and really think about the concept. If the instructor goes to PIP format, it means that the instructor is implicitly showing the student that they need to be watching what the instructor is drawing.

During a teaching session, the student may want or need to pose a question to the instructor or share information with another student. When a student cannot answer a problem in their notes from class or a handout, it is difficult to recreate the problems by typing. Instead of typing it out the student may take a photo with a mobile device and post it to the class wall and ask their questions about it. By way of example, the student may take a photo of themselves pointing to a part of their notes they do not understand. Taking a photo is much easier than typing out long questions. The student is more likely to ask questions when it is easy to do so, and taking a photo and possibly adding some text with it (optional) is easier than typing an entire question. Additionally or alternatively, students may help each other by taking a photo that was posted by someone else, and then put it in a drawing program so one of the students may interact with the photo to point out, in real time, what needs to be modified or clarified.

When posing a question, the student may present the question on a virtual wall in the online learning environment, similar to a post on a social media site. The wall may operate as a discussion wall where students post questions and other students or the instructor may respond at any time after the post shows up on the wall (e.g., even days or weeks after the post appears on the wall). The wall may be attended to (i.e., questions answered) by the instructor or by a person assisting the instructor such as, but not limited to, a tutor. To close a post on the wall, the instructor or the instructor's assistant may take a final act to make the post closed.

The instructor may filter the wall for unclosed threads so the instructor can answer questions and close threads. For example, the instructor may filter out all the threads where an instructor is the last comment in the thread. If the last post in a thread is from an instructor, or if the instructor has liked the last post in the thread, then the thread may be closed. This would diminish or eliminate the need for other instructors to read though the closed thread. If the student replies back on the thread, then the thread may automatically re-open and the instructor may be notified that they should respond.

Another embodiment of the present invention is directed toward protecting content used in an online learning session and to prevent students or others from sharing or using a single student account. By way of example, the students would be required to log in with a username and a password that is the same or at least similar to a password used by the student for non-learning activities such as, but not limited logging into a social media site. Because students would want to keep access to their social media site private the student would be incentivized not to share their password for online learning with others.

Additionally or alternatively, the learning institution may charge for online learning content through a token system. The student purchases a package with a certain number of tokens and each piece of learning content (e.g., video, pdf) would require one or more tokens to be purchased or made available to the student. Such a token system may prevent students from sharing accounts with others since there is a limited amount that can be consumed. In another embodiment, the may use a payment system such as, but not limited to, a credit or debit card and receive monthly bills. Each successful monthly payment may result in a replenishment of the tokens allotted per month.

In yet another embodiment, when files are uploaded to a server through an administrative portal, the name of the document may be automatically changed to a random string of characters before the document is saved or stored on the server. Such an automated naming convention may also be advantageous in preventing students from saving content that is not supposed to be permanently saved by the student.

To prevent students from creating fake accounts and sharing it with others, the learning institution may have a friend threshold rule. By way of example, a one hundred (100) student friends rule may prevent students from watching videos if they have less than fifty (50) student friends. So if student created a fake account, the student would need to find fifty other student friends before the student would be allowed to watch any learning videos. This same rule may also prevent the student from purchasing learning items such as documents if the student has less than 100 friends. Since the student is first told they must have fifty student friends to watch a video, the student will not likely go all the way up to one hundred student friends before they purchase a learning item. When a student or another person attempts to purchase with less than one hundred student friends, the learning institution would transmit an error message, but does not necessarily need to disclose the reason for the error message. When contacted by the student, the learning institution may create an exception if it is determined the student does not have a social media account or if it is otherwise determined the student is not involved in a scam.

Additionally or alternatively, the learning institution may generate one or more reports that notify students whether they have watched one or more learning videos in a particular number of subjects over a predetermined number of days or weeks. In addition, the learning institution knows the specific combinations of courses that students are able to be enrolled in, and can identify those who are scamming by sharing accounts. For example, a student cannot be taking calculus II and calculus I at the same time. Students are also contacted and prevented from using resources if such behavior continues.

To prevent account sharing between learning institutions, the learning institution may generate a report that identifies students watching videos in two or more schools over a certain time period.

The content may take the form of existing content or new content. In one embodiment, the content may be uploaded to a database or server. By way of example, the process of uploading videos for a new class may start with the creation and organization of folders that represent chapters in the textbook. Within each chapter there may be some pre-recorded material (e.g., about eighty percent (80%)) and some custom material (e.g., about twenty percent (20%)). Because instructors may each teach a little differently the content may be selectively and deliberately adjusted, revised, re-organized, etc. by the instructor.

When a student posts on the virtual wall in the learning environment, the student selects their instructor. This selection permits the learning institution to know which students are associated with which instructor without needing to first obtain roster-information directly from instructor. Accordingly, the instructor may then tailor a response to the student based on the instructor's knowledge of the organization and content of his or her course.

In another embodiment, the learning institution may provide karma points to one or more students in an online learning environment. Generally, the issuance of karma points is reserved for instructors, which may include tutors. By way of example, karma points may be earned when a student directs a peer to a correct learning resource, guides a peer to a correct question on a wall, or otherwise provides an incentive or encouragement to another party to spend more time on the online learning site. Further, the students may answer another student's question, and then a moderator or the instructors could ensure accuracy and award karma points. Accordingly, the instructor does not have to be the one to answer a student's question, but instead another student answers a first student's question, and then the instructor verifies the answer.

In one embodiment, a leaderboard shows a monthly and a lifetime ranking of karma points earners. By way of example, a student may selectively filter the leaderboard to search for students in their learning institution. The leaderboard may also be set to automatically detect a grade level of the student (e.g., middle school versus high school). Thus, a middle school student would be restricted to viewing rankings of only other middle school students and a high school student would be restricted to viewing rankings of only other high school students. The karma point system may allow students to immediately compare themselves to their peers, and allow the instructor or the learning institution to create positive competitions.

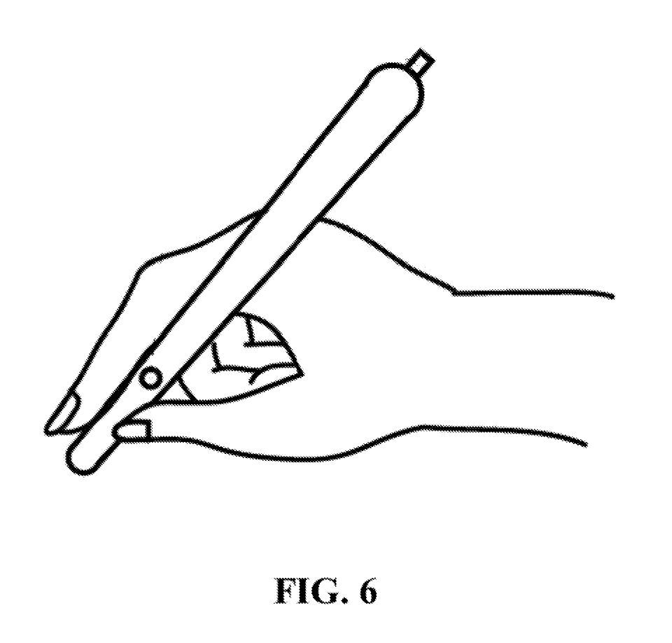

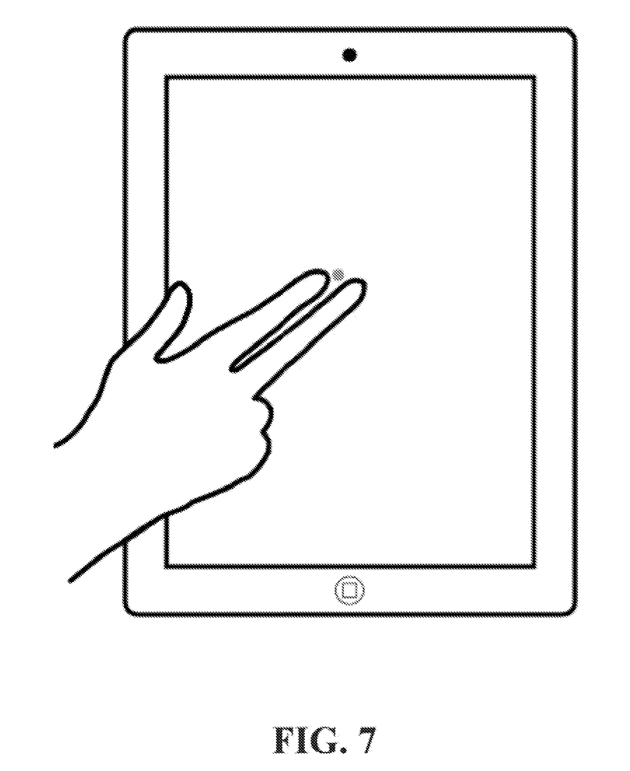

FIGS. 6 and 7 show a stylus that operates similar to a mechanical pencil. In one embodiment, the stylus includes a button that may be operated by a person's index finger wherein pressing that button shoot an electronic laser that puts the laser on the screen and you could point to stuff. Touching the stylus the stylus on the screen would cause the person to draw on the screen. Toggling the button would cause the stylus to function like a pointer or a laser pointer to allow pointing without drawing on the screen.

So that is if user number 1, who's the tutor, circles, user number 2, who's the tutee, sees the circle but then it dies out slowly it trails off, it kind of fades away. So yeah that's part of it. You could also do it with a push button, you know like with a normal ball point pen where you click to let it out or let it in, you could click with your thumb and that would turn on either writing, or you could click it again and it would be a laser pointer. And if you clicked again it would be back to writing and if you clicked again it would be a laser pointer.

Anyway, there are people with styluses, the point is to add a button either under your index finger or under your thumb or at the top of the stylus where you would click it like where the eraser would be on a pencil. You would click that and, or you would hold it down with your index finger, or click it with your thumb, but if you held it down with your index finger, if you were holding the button that would mean that it would not draw. It would just do a temporary laser pointer trail. When you're private tutoring somebody in person, the one thing that you're able to do that you're not able to do online is to point at stuff. Like when you're sitting and showing somebody something, you point at different parts of the paper.

A special pen, stylus, or writing device may emit a wireless signal (such as bluetooth, wifi, ultrasonic) when the laser pointer button is pressed. This button may either toggle on/off the laser pointer tool or may turn the laser pointer tool on so long as the button remains depressed. The wireless signal that is triggered by this button may tell the device and subsequently the application to stop writing on the screen and instead show a dot that may not leave a trace or mark up the screen.

Note that the dot may have a particular, a particular shape, and may provide a trail. But optionally advantageous is that it does not affect the actual drawing. Or it could affect the actual drawing.

Also note that the stylus could be pressed against the screen to write or to point with the laser, or it could be held in the air and the direction of the stylus could be determined by the screen/device. So you could point like with a laser pointer at a conference when you point at a presentation with your real laser pointer, but the difference here is that the person on the other end of the video conference would see the laser pointing on their screen, when the teacher is touching the stylus to the screen or holding down the button. Would the teacher may also see the laser dot the teacher's own screen. However, it might not be necessary because if the teacher is touching the screen with the stylus, the teacher knows where the teacher is pointing. It's the student who is across the world and can't see that the stylus is touching the screen or where it's touching the screen. So the student would be the one who really needs to see the laser red dot or whatever it is. So the dot could be created when the stylus is touching the screen or when the stylus is pointing at the screen, but not touching it. And the dot would be turned on and off either by touching a spot on the screen, or depressing the button on the stylus, or holding down the button on the stylus. Also, TWO users could both have these devices. And it could be a blue dot or other color and shape for one user vs. red for the other user. OR, both users could use red dots, but each user would only see ONE red dot (the other user's pointer/laser). So it wouldn't be a problem of confusion for either user. Also, the teacher could use their finger to point and the stylus to write.

This provisional patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

An embodiment includes TMS's (Tutor Matching Service) website, tutormatchingservice.com. The Facebook app: normally says TMS at the top. Click ‘Find a Tutor’ and it's like kayak.com or hotels.com or travelocity, where it's going to show all the tutors when you first come in and then you just filter them down. Here are all of the tutors where, you can see ratings and all that kind of stuff. There are over 1,100 tutors, the average price is calculated, average rating is calculated. You can sort by most ratings, lowest price, highest price. You can filter by school and subject.

When you filter by school, the top of the page may display the school. When it's not filtered by school, the top may just display the TMS logo. For subject, you can filter by ‘Math’ and then filter by ‘Calculus’ or other smaller subjects of Math. Tutor profiles show if a tutor is fully booked and some other info about them, every one has a 100% guarantee. You can also filter by course code (for example, ACG2021 is financial accounting at University of Florida, ACCT2102 is accounting at the University of Georgia), which is populated by the tutors themselves as they add stuff to their profiles. Or you can look by a tutor name, or by a maximum price, or by a minimum rating. You can also sort by availability (like Sunday/Monday/Tuesday/Wednesday etc), shows tutors available based on their calendars. It also shows university-certified tutors. University certified tutors are shown with a badge next to their names that say that the school has gone in there and certified them. You can also sort by live, in-person tutors and online tutors.

The 100% money back guarantee is great because every tutor has to agree to the 100% guarantee. Under Admin Tools [at the top right], there's all kinds of admin tools. There's also ‘Tutors: My Account’ and ‘Students: My Account’ [also at the top right]. Tutors can sign up and put their availability and such, if they'd like. You can buy a package, so you can put money into a facebook user ID's account, and that facebook user ID can go spend that money with whichever tutor that they want.

The background on TMS: it's an online marketplace for private tutoring, tutors sign up for free, students go and book them and we withhold a 10% booking fee from the tutors' paycheck which we send through Paypal. The first thing to talk about is the online tools. We're matching a whiteboard with skype-like video.

We do have a very easy way for people to get into the white boards with others, which is that instead of having passwords and getting into different boards that way, when somebody enters the app they're immediately assigned a randomly generated 5 digit alpha-numeric room that they're in, ‘tutormatchingservice.com/abcde’, for example. And then, so they're in a room and they can draw by themselves, and they immediately see how easy it is and what tutor matching service is, so that's very helpful in making people understand when they first come in what it is. They're stuck in a room immediately, and they're told exactly what room number they're in. [1:25] There's about a 1 in 60 million chance that somebody guesses somebody else's room, so it's ‘security through obscurity’. Then, when somebody wants to invite someone else, they can just call/email/text/or click the button that sends their friend an email message that says “Hey, go to tutormatchingservice.com/abcde” and it gets them into the room very very quickly and easily as opposed to having people create rooms. Nobody ever creates rooms, essentially 60 million rooms already exist, and uh, so you're just stuck into one of them randomly. [2:11]

The individual tools on the whiteboard. An embodiment includes a laser pointer on the white board.

An embodiment includes if you have a stylus, if there's a little button on the stylus like those mechanical pencils that you push your index finger into and it lets the lead out, [2:56] if there was a button on the stylus that would allow you to press that button and it would shoot an electronic laser that puts the laser on the screen and you could point to stuff. Whereas, as soon as you put that pen down to the screen you're drawing, you're drawing on the screen. [3:11] But if you held the button down and drew on the screen, it would only do the laser pointer. You could draw, it would actually be very easy for a tutor to use.

One person clicks on the laser tool, and they draw around with their finger on the screen, and it doesn't actually draw anything but the other person who's watching what they're drawing they see a little laser dot moving around the screen, so you can point at this things.

Without drawing on them. Potentially a trail. So that is if user number 1, who's the tutor, circles, user number 2, who's the tutee, sees the circle but then it dies out slowly it trails off, it kind of fades away. Complete separate idea is to do it with a hardware device [4:24], which is like an iPad if an iPad came with a stylus. You could also do it with a push button, you know like with a normal ball point pen where you click to let it out or let it in, you could click with your thumb and that would turn on either writing, or you could click it again and it would be a laser pointer. And if you clicked again it would be back to writing and if you clicked again it would be a laser pointer.

Anyway, there are people with styluses, the point is to add a button either under your index finger or under your thumb or at the top of the stylus where you would click it like where the eraser would be on a pencil. You would click that and, or you would hold it down with your index finger, or click it with your thumb, but if you held it down with your index finger, if you were holding the button that would mean that it would not draw. It would just do a temporary laser pointer trail. [5:29] It would make tutoring a thousand times easier because the problem is it's not obvious that when you're private tutoring somebody in person, the one thing that you're able to do that you're not able to do online is to point at stuff. Like when you're sitting and showing somebody something, you point at different parts of the paper. You can't do that with an iPad because you're either touching it and drawing something or you're not, on a whiteboard. [5:59] Let's talk about the marketplace itself. So there's tutors and students and the 3rd party is TMS which runs the marketplace. But there's a fourth party as well, and the fourth party is certification. So there's an outside certification for this. But with our system, how do you signify some tutors vs others, the quality of some tutors versus others. And, in one embodiment, the tutor puts in a unique code that has been given to them when they walked into the learning center on campus. So the learning center gives them the code, the student puts in the code on their profile when they're signing up as a tutor [6:58], so when the tutor signs up they put in that code, and that grants them the badge, but nobody else gets the badge because they don't know the code.

Another embodiment is that TMS staff emails the school every week or however much the time period is, and says “hey these students have signed up, they've said that they go to this school, or that they're certified by this school, are they certified?” In which case the school then emails back and says yes or no. And then TMS goes into its admin area, and turns it on or off for those tutors.

Another embodiment is where the tutors sign up and they check a box saying they believe that they are a certified tutor, and then they type in which school they believe they are certified with, and indicate which badge they should get from which school. It then sends an email over to the staff person at the school, and the staff person at the school gets that email and they can click a link in the email to either accept or reject that application/request. Or they can click to go to an online web portal in tutormatchingservice.com where they can click yes or no for every one of the tutors that are in a staging area. We put the tutors in a staging area. They [potential tutors] sit in the staging area to decrease the time and effort that the school would need [to expend] to get those badges up there.

Another piece of is the guarantee. We hold the money in escrow, essentially, the tutee books the tutor and pays the tutor up front. We charge the tutee's credit card, the money goes into TMS's bank account, and then 48 hours after the session, TMS automatically electronically allows the money to flow out to the tutors' paypal or bank account but only if no refund request has been requested by the student. If the student does make a refund request in that 48 hours, TMS can send the money back to the student.

Another embodiment [9:58] involves, through mobile apps or through the web, that after the session is over, instead of automatically transferring the money 48 hours after the session, both the student and tutor click a button right after the session to disburse the funds. Or maybe just the student does it. Maybe the tutor reminds the student right after the session. Through mobile, which is another piece of this, the students can look for tutors, the tutors can check their schedules. Mobile could be cool because if you're at a tutoring sessions and you want to release money or if you want to pay the tutor some extra money or if you want to extend your time with the tutor/book another session [11:12] concurrently or right after it, you could do it on the mobile device. You could pay it right there on the mobile.

Then there's the part about matching tutors with Myers-Briggs and the mutual friends. Let's talk about the mutual friends. So, facebook allows you to see mutual friends, that increases safety for an 18 year old girl who wants to meet up with somebody in the library, she can check and see her mutual friends. We show the mutual friends on the tutors' profiles actually so whenever a student clicks on any tutor, they can see any mutual friends that they have. Either we show the mutual friends they have or we don't even mention that there is such thing as a mutual friends feature. So if there's no mutual friends, we just don't show anything about mutual friends so they don't—we don't want to advertise the fact ‘hey you don't have any mutual friends’, we just hide it altogether. So this increases safety. The mutual friends could also go into the algorithm of sorts for which tutors are shown first when a student goes shopping for a tutor. And the question is which tutor should be shown first when filtering by price or availability or those types of things, which we should also talk about the filters as another thing, [12:28] but when it comes to that score, we'll call it the tutor score or match score, the match score could be based off of how much availability the tutor has. The more availability the higher the score, therefore the higher the results. It could be based off of how many mutual friends the person has with the tutor. Or second level friends, or third level friends. Could be how many people are in the same network as you. It could also be based off of Myers-Briggs questions, either the actual Myers-Briggs type (four letters), or it could be based off of a made-up mini Myers-Briggs that we come up with ourselves. It could also be based off of previous ratings that the student has given a tutor before (the score of what brings them to the top of the results). It could also be based off of low price. It could also be based off of congruent subjects or course code that have been searched for. It could also be based off of overall ratings of the tutor before.

What else can go into our score though [13:48] Interests being aligned on facebook profiles, if you like some of the same books/sports teams/if your likes are some of the same things.

[14:35, other things that could go into a score] How recently they've been booked, how many hours they've tutored before on TMS. How far they've gotten in school (like graduate degrees). What school they go to, the better the school they higher the score. How many times they've been contacted been other students. Eventually there's going to be a perfect way to score it.

Score would be assigned in relation to a bunch of other people in the database. Scores would be incremented in certain ways so I guess these are the ways that we would increment that for whatever machine learning algorithm we do.

The score will be interesting in how we match those tutors. Another one is called the Learning Match. We could do 5 red circles. And more of the circles are colored in as there's a better match with the Myers-Briggs questions that we ask them (and we can weigh the different-parts of Myers-Briggs based on our understanding of Myers-Briggs: if people are top-down learners or bottom-up learners we can ask them questions about how they prefer to learn and then we can match them up to tutors based on that. In other words, the tutors won't just have their own score, but they'll have a score relative to each student. They'll actually have 2 scores. One is an absolute regular score that works across anything, and the other is how well they match up with that particular searching student. Then we'll weight those two scores together to find the perfect tutor for them.

So then another thing is the filters. The filters where students search for price, maximum price, availability (day by day, day of the week, hour by hour), whether the tutor is certified or not, ratings, knowledge of the material, presentation of the material, how many students have left feedback of the tutor, subject (biology or chemistry or chem2), course codes. Course codes are automatically created in the system where as the tutors put in their course codes, and we have systems to clean up those course codes, instead of having to download all of the course codes from different schools, [17:40]. Schools have said they'll upload their course codes which is unnecessary because the tutors can populate that themselves, and then the list grows for each school in an ongoing basis.

There's the tutor area, there's the search, there's the cross-platform aspect of it.

Require users to leave feedback before they can book another tutor or even the same tutor again

So that we ensure each tutor is not evaluated by a skewed sample, we require tutors to leave feedback before continuing to use our app. A user cannot book or message other tutors until they have provided feedback for all previous sessions.

Laser Pointer Tool

In a collaborative online studying environment, one may want to utilize a laser pointer to point out certain elements in a text, picture or drawing without writing over it. This can be accomplished with a laser pointer tool. The laser pointer tool can be used in two ways:

1. The laser pointer tool is selected from the menu bar within our whiteboard/collaborative learning app. After selecting this tool by tapping on the laser pointer icon, a user can tap and drag on the screen and a red dot may appear where this user is pointing on the screen of all members of the session. It is different from other tools because it does not leave a trace or mark up the screen.

2. Using multitouch on the screen (two or more fingers touching the screen at the same time) may bring up the laser pointer tool. The red dot may appear at the midpoint/centerpoint of a user's fingers and of all members of the session may see this red dot on the screen. This tool may not leave a trace or mark up the screen.

3. A special pen, stylus, or writing device may emit a wireless signal (such as bluetooth, wifi, ultrasonic) when the laser pointer button is pressed. This button may either toggle on/off the laser pointer tool or may turn the laser pointer tool on so long as the button remains depressed. The wireless signal that is triggered by this button may tell the device and subsequently the application to stop writing on the screen and instead show a red dot that may not leave a trace or mark up the screen.

4. Note that the red dot could be another color, another shape, and/or could be a ‘trail’ that is left. But optionally advantageous is that it does not affect the actual drawing. Or it could affect the actual drawing.

5. Also note that the stylus could be pressed against the screen to write or to point with the laser, or it could be held in the air and the direction of the stylus could be determined by the screen/device, just like an Xbox Kinect. So you could point like with a laser pointer at a conference when you point at a powerpoint with your real laser pointer, but the difference here is that the person on the other end of the video conference would see the laser pointing on their screen, when the teacher is touching the stylus to the screen or holding down the button. Would the teacher ALSO see the laser red dot or whatever on their OWN screen? You could do that as well. However, it might not be necessary because if the teacher is touching the screen with the stylus, the teacher knows where the teacher is pointing. It's the student who is across the world and can't see that the stylus is touching the screen or where it's touching the screen. The student would be the one who really needs to see the laser red dot or whatever it is. The dot could be created when the stylus is touching the screen or when the stylus is pointing at the screen, but not touching it. The dot would be turned on and off either by touching a spot on the screen, or depressing the button on the stylus, or holding down the button on the stylus. Also, TWO users could both have these devices. It could be a blue dot or other color and shape for one user vs. red for the other user. OR, both users could use red dots, but each user would only see ONE red dot (the other user's pointer/laser). It wouldn't be a problem of confusion for either user. Also, the teacher could use their finger to point and the stylus to write. so if the devices sense a finger, it knows to do the laser dot, and if it sees the stylus then it knows to write.

Tutor Certification Staging Area in Admin Tools

In order to limit the time schools spend certifying tutors, we allow them to certify tutors in batches. If a tutor believes he/she is certified by a partner university, we may allow tutors to self report certification from a school. When a tutor self-reports, their request for certification is sent to an inbox for school admins. School admins can check this inbox periodically. The inbox is a list of requests showing the tutor name, time of request, and any additional information necessary about that tutor. For each entry, the school admin can determine whether a tutor is actually certified or not and accept or reject their request for certification/assertion that they are certified. It's essentially a holding tank. The tutors could sit in there, waiting for us or the school to approve them, or they can go right into the tutor list but without a badge until the school has time to go and verify if the tutor is legitimately a certified tutor.

Hold Funds Paid by Students, Pay Only if Satisfied

In order to ensure quality of instruction, funds from students are not immediately disbursed to tutors.

Instead money is held and disbursed in one of the following ways:

1. The money is held until 48 hours have passed without complaint or refund request from the student. If there is a complaint or refund request, money is returned to the student.

2. At the end of a tutoring session, a tutor requests money from the student using our app and the student has the option of either releasing funds or asking for a refund.

We can also use a different amount of time to wait, or have different lengths of time based on algorithm across other factors like the rating of the tutor or how many times the tutor or student has booked or been booked.

Allow Schools to Input Course Codes or Aggregate a List of Course Codes Programatically

In the school admin tools, allow schools to upload a CSV with all of their course codes or enter them manually. If we do not have school course codes we may store course codes in our database in a way which associates them to the user. That way we can programmatically determine which course codes belong to a certain school based on the student's school affiliation. (Or put them all in one huge database. Or we can allow tutors who create profiles to be automatically populating the course code list for that particular school or schools.)

TMS Relatedness Score

Student tutor compatibility is calculated using an algorithm that takes into account subject needs of the student, expertise of the tutor, mutual friends, as well as personality types and personal compatibility (Myers Briggs based assessment). These are calculated into a relatedness score between users in our system. We may display this relatedness score when a user sees a tutor profile and may allow students to sort by this score in their marketplace results. It could use any one of these items, or a combination of them, and not all of them.

Study Edge—

This is how Study Edge works. People can go to our app by just typing in ‘Study Edge’ into the facebook search bar. Or they can go to our facebook fan page and go straight to our app. But either way, it comes to the app. When students first go on, it goes to a page that asks them to type their school. Then, they choose their subject <apptour1>.

There are a bunch of subjects listed that we already do, followed by subjects that we can later activate (these subjects are specific to whatever school you choose).

We'll go to financial accounting [as our subject]. Once we choose that, we go to that subject's page. We can change the subject by clicking on the subject and choosing another one from the drop down menu. You can stay informed so that you can get emails from the class [by checking the ‘Keep Me Informed About This Class’ box].

[0:50] There's a check in so that people can check in and check out of the study edge library. Below that is the video player. People can watch the intro video at first. Below that is the ‘Videos and Documents’ section.

There are Chapter folders <apptour2>. Under Chapter 4, there is an announcement which takes 0 tokens to view. In the chapter folder there are also folders for ‘Chapter Review Sessions’, ‘Practice Problems’, and ‘Short and Sweet Concept Videos’.

Under Chapter Reviews we have Part 1 and Part 2, and a PDF study guide to be downloaded as well <apptour3>.

Under Practice Problems there are practice problem solution videos, and the PDF with the problems themselves [1:25].

<apptour4>Under Short and Sweet Concepts there are short concept videos explaining different concepts, and the PDF with the concepts. When someone clicks on a short concept video the video player starts up.

When you click on the video player to play, it starts with the Study Edge logo <apptour5> [1:50]. There is a box under the player showing the ‘Tokens Remaining’ balance and the ‘Replenish Date’. If there's no replenish date for the tokens they can click on a button below it to go to ‘My Account’.

In the folders we have the videos, documents, and announcements as well.

We have the Class Wall, where students can post back and forth <apptour6>[2:40]. There's also the My Karma Points tab next to the Class Wall tab. My Karma Points explains the concept of karma points, shows how many karma points the student has, and shows the monthly leaderboard in karma points <apptour7> [2:56]. You can also see the lifetime leaders in karma points.

The “Want a Private Tutor” box allows students to find private tutoring via Tutor Matching Service <the black box in apptour7> [3:09]. So down on the Wall, a student posts. Next to the student's name is their school, and what type of member they are (silver/gold/diamond VIP/none. The icons shown are different for each level, which differ by price and benefits).

When a tutor posts (called Study Experts), they have a special picture on the left of their post and a ‘Study Expert’ ribbon on the right <apptour8> [3:32]. There is an option to watch a video with their bio by clicking on ‘Watch Bio’. Students and tutors can go back and forth with posts, and there are several tutors who post on the wall. Tutors (Study Experts) can give out 100, 200, or 500 karma points to students and can also delete posts. To the right of a student's names their karma points are displayed. At the very bottom you can click ‘Show 20 More Posts’ which shows 20 previous threads [not posts] not currently being displayed. <apptour9> [3:58].

Posts can be ‘liked’, you can search by posts by a post's post number that is displayed [by typing the number into the Search Posts bar above the wall. You can also just search by key words]

[4:15] You can also click on ‘Draw Something’. You can use this feature to help demonstrate something <apptour10> [4:26]. We're also adding symbols so you can add symbols like square root signs, exponents, stuff like that.

Students ask questions on the Wall, they can also take photos with their iPhones/Android phones and post photos of their work on the wall [4:49].

When you go to the ‘Change School’ option and type in a high school, the app brings you to Algebra Nation <apptour11>. This page also has the Keep Informed option, checked in to the library display, and intro video. It also has the Videos & Documents section.

Instead of chapters, different sections are shown (such as Sets and Venn Diagrams)<apptour12>. Under each section are concept videos, a PDF packet, and a Test Yourself practice tool. The Test Yourself practice tool looks like the EOC, tells students what they got wrong and right, and offers solution videos for each question <apptour13, apptour14> [6:04]. There is also an onscreen calculator that we built <apptour15> [6:16].

Back to the Section folders: when a video is watched, the link becomes gray so students know they already viewed those videos. You can also click on collapse all folders to bring everything back to just the main section folders <apptour16>.

Below that stuff is the Wall. Posts can be tagged by period and teacher <apptour17> [6:43]. Only the teachers at the selected high school may be available to choose from. Students can post back and forth to each other just like the Study Edge wall, with tutors (Study Experts) commenting as well. There are also teachers that post comments that have a Teacher badge to the right of their post instead of a Study Expert badge. Students can also upload pictures and use the Draw Something feature. Threads are often quite long with students, study experts, and teachers chiming in <apptour18> [7:13]. Post numbers are also displayed as with the Study Edge app and can be searched for. When a student posts, their high school is displayed to the right of their name, their teacher and period number, the amount of karma points they have (if any), and there is an option for study experts to give them 100, 200, or 500 karma points. Posts can be liked or commented on. Clicking on a Study Expert's thumbnail picture/name brings you to their facebook profile [however, students can't click on other students' names to go to their profiles. This helps prevent bullying]. Study Eyou

The iPhone and Android apps do the same things, with the only difference being that the iPhone/iPads apps allow you to take photos of what you've been working on [8:22].

There's also Admin Tools which has all kinds of reports <apptour19>. Teachers can also pull reports on their students as well. Teachers can see what their students are posting, what questions they're getting right/wrong, what videos their students are watching, how many times the students are posting on the wall, all that kind of stuff.

Study Edge—Studio Tour

Here's the Studio, there's Andrew standing in front of the green screen [0:03, studiotour1], with the lights, two lights, then one on the bottom [studiotour2].

Andrew looks over here and he's got the face cam, this is the face cam. He sees himself, and in addition to seeing himself is he can see what's being broadcasted to the students [0:11, studiotour3].

He's got a headset microphone that he puts on there [0:21, studiotour4], and he's got a packet in front of him.

Camera number 2, that's the document camera, above his head. [studiotour5]

He can see, from his perspective, looking right here, he sees a preview window and a live window using some software called Wirecast from some other company. But, he, like myself sees it with a white background instead of the green screen. [0:32, studiotour6]

Let's change the background to a funny Picture in Picture (PIP), but you can see that we are in front of the green screen. [0:48, studiotour7]

Now, down here, we have a MIDI, a musical instrument, and we put names like ‘Record’, a button to record, ‘Logo’, ‘Face’. Andrew, can put his four fingers off camera there [1:06, studiotour8].

While looking up at the camera, with his eyes on the camera, he can hit logo, and then he hits face cam, and back to logo [1:13, studiotour9] just by pressing the buttons off camera. You can see his face and he can smile and he can say ‘hey we're good’ and people don't know that he's switching camera angles.

This is our Picture in Picture (PIP) angle [1:24, studiotour10]. Here what we've done is the document camera is being fed into the background of the green screen. You can see that we're only losing the text that's right behind him. Normally in a square box, a square Picture in Picture, we'd be losing all of that text, but instead we're only missing what's behind his head. [studiotour11]

Even on the other side of him, we're only losing this very small amount of space, and on a smaller screen, like a mobile device, that really matters.

Let's go to document camera. Andrew hits a button, he disappears, now it's straight doc cam [studiotour12], let's go to the face cam. There's face cam [2:16, studiotour13], and then back to PIP. We've got the watermark moving with the transitions [2:20, studiotour14]. And there's no post editing at all.

[2:23] To start a video, Andrew will hit the record button [studiotour15]. It lights up. And now he knows he's recording just by looking down. Now we can start with the logo, and he says ‘hey guys’. He can be looking up while he's changing to logo/other camera angles [2:38]. He can be talking to students. He can show his calculator while he's recording [2:54]. He can also pick up the calculator and show it on the face cam, then go back and show it in the doc cam [3:02]. And students can be seeing the tutor and the piece of paper and the calculator all at the once [3:17, studiotour16]. That's the face cam on Andrew and that's the document camera up there [3:15]. Using consumer-grade camcorders. He goes back to the logo at the end, and then hits the record button to turn off and the video is over. We upload it to FTP to Akamai and Akamai delivers it [3:27].

We put 2 HDMI cords [3:32, studiotour17] that allow 2 HDMI camcorders to go into the Mac Pro. We have 2 HDMI camcorders coming in. The Mac Pro is compressing everything with that Wirecast software. It takes two inputs and then we use the greens screen to do that.

Study Edge—

First of all we have the app, there's lots of stuff related to the facebook app, and there's also the iPad app and Android app. There's mobile as well. We've got some stuff on the app, we've also got some random things like Tutor Training, which we're probably not going to get into on this one, but our training process on how we train our tutors. Things like how we have them give a dry run first, don't say anything, then the second time we interrupt them and stuff. All the different kinds of ways we train tutors. So tutor training we're probably not going to talk about in this video because it's interesting, but not that interesting and we need more guidance on that.

[0:40] The app is mainly what we're going to talk about, our processes, and then we'll talk about videos as well to just talk about how we do videos and studios. What we'll do is we're going to do a tour of the studio on video later and how we set things up with really cheap cameras and do it for 10 grand instead of 50 grand [0:57].

Let's talk about the videos first. First thing is the picture in picture [PIP] thing that we do. Nobody's figured it out yet, you can shrink the tutor and the text into a much smaller screen instead of having two different screens or having a square and losing space over your shoulder. Okay so that's number one, we can show in the studio how that works. [1:16] With the two cameras and the green screen, people look at those videos, people have walked in here, and they don't know how to do it. They don't know. They think it's computer generated over later but we do it on the fly.

[1:37] Let's talk about the app.

1) Everything all in one place. Videos, documents, announcements, and the wall for asking questions.

2) Using social media logins. Because all the districts have different systems, and integrating all the different systems is a disaster because they all have their own user names and passwords, but all of them have a social media login. [2:29]

3) Connecting students from across the state (Algebra Nation) and the country on one system (Study Edge)

4) The way that we tag posts by professor/by school/by textbook/anything else. We tag the Chem 1 wall by school and by teacher. The reason why we do school and teacher is that some schools have multiple professors that teach different things, so students can know what to ignore and what not to ignore based on having both. Even at one school there could be 5 professors teaching different stuff. We can tag it by school or by professor or by textbook, and students can look at one wall and see a bunch of activity, but it's not so convoluted that they can't figure out what's going on. [4:03]

*one number could represent several different things*

5) Searching posts by keywords/post number. Linking a post by a hashtag or an @ symbol or something like that, it directly goes to original post with information. Could turn it into a hyperlink and either pops it up onto the screen above and blacks out the rest of the screen or it actually just brings them down on the Wall to where they need to be.

6) Bonus videos on the Wall [5:40]. With bonus videos on the wall, the idea is that we charge for content, so charging for content in general is part of this, and how you charge for content and how you protect the content. As for the bonus videos, there's videos up top on the app, and there'll be a tour of this on the app, but the idea here is that when students click on videos, they use up some of their tokens. When the tokens are gone, they have to buy more tokens [6:01]. On the Wall we want to encourage students to ask questions. We don't want to charge them for those bonus videos because we're just answering a quick question for a student. What we do is we go and record a solution with our finger and talking with a webcam or with an iPad app, then we paste that link over into our Wall. Once it's posted into our Wall, our app sees that it's from like screencast.com/2956 or from educreations.com/2956, our app hides that and puts the image called ‘Bonus Video’ and then students can click on Bonus Video and it pops up that video on someone else's server maybe or on our server. Either way it shows them a video but it doesn't charge them for that content. It makes it very easy for us to leverage other people's stuff to record videos on the wall [6:46].

Draw Something on the Wall [37:07]: Draw Something, and symbols and photos from the mobile, or pasting from other sources. Pasting in videos from youtube. Using the html for bold or italicize or underline to keep the Wall clean like facebook, but allow some people to customize stuff [37:46]. Like Myspace, without getting too much like Myspace, is to allow bold, italicized, or underlined code. Only the admins know about it. Students could use it, they just don't know about it. It's like security through obscurity basically. It doesn't get dirty and ugly because if we give them emoticons and bolding, kids would go crazy, so this way only the Study Experts know about this because those are the only people told about it.

[38:27] Just for the app to relatively fast and not be ugly with this huge long page and scare people, we may only show 20 threads at a time. At the bottom of the Wall, when you scroll down and reach the Load 20 More Threads part, it'll automatically load the next 20. That way students can go back in time if they want to, but they don't have to see an intimidating long text in front of them. They just see the first few pages, and then more pages and more pages. Also, you can filter posts by only your school, only from your class, it's already by subject, but you can also filter by only my posts, by just my facebook friends' posts, by my school's posts, by my professor's posts, by my textbook's posts, all of those things can be filters as well. So all of the content is there but then you filter it down. [39:29].

7) When posts are commented on, we move it to the top of the Wall. So there could be a post with a bunch of comments under it, and another post with other comments. The post with the one most recent comment may be listed on top. That way we can always have the most recent stuff on top.

8) Also we have unfinished threads [7:40].

9) With the moderators of the wall, they want to see the threads that have not been finished, the students have not gotten their answer. The problem is a lot of times students/moderators may post back and forth and then what we do is, we want a queue. We want a queue of what hasn't been finished yet. So how do we do it? How do we get a finished thread out of there? We have a dropdown menu that says show all posts or show unfinished posts. Unfinished posts means that either the last post was not a moderator (could be student), then that hasn't been finished yet. We could finish a thread by having a moderator “like” the last post. Then the thread is marked as done, or marked as finished. Just need one or the other or both. Instead of having thousands of threads we can just sort by the unfinished threads. We can filter by Unfinished Posts, like posts, empty the queue, and just wait for students to ask more questions. It has to be the last comment on a thread because students may comment and thank us, but our system doesn't know it's really finished. So we can either write back “you're welcome” or we can just like their post. We don't have to make some kind of artificial you're welcome, we can just press like and clear it from being an unfinished post and then it's out of our queue [9:34].

Moderators are Study Experts who work for us, either part-time staff or full-time staff, and also we have teachers who little ‘Teacher’ flags. Either way, we denote them by teachers getting a flag next to their name that says ‘Teacher’, and Study Experts have a blue border around their photo that says Study Expert. Study Experts also get a flag next to their name saying Study Expert. Students know exactly who's smart and who's not. Or who they can trust and who they can't on the Wall. The whole idea of students helping each other, and peer learning, need some chiefs, can't just have Indians. The Chiefs are Study Experts from our staff, and teachers as well.

10) Karma points. We also want the students, ‘the Indians’, to know which Indians are smarter than other Indians. We have Chiefs, but we also have smarter Indians. So we give out karma points. Only Study Experts and teachers (moderators) can give out karma points, because if students could give each other karma points, that doesn't work out very well [11:28]. Only the teachers and the Study Experts can give out karma points. The karma points balance is shown for every student. They start with 0 karma points, and they can get 100, 200, or 500 karma points at a time. That's how we do it but you can do it however. 100 KP's is for asking a question or being involved. 200 kp's is for doing a good job, answering somebody else's question, like a student answering a student. And 500 karma points is if they really did an exceptional job, like if a student helps another student from another university at the college level, or if they just provide really great information. You have different levels of that [12:06]. Basically the karma points set the different levels of how smart people are. Or how trustworthy they are. No karma points means you can't really trust them, some karma points means you can sort of trust them, a Study Expert means they work at Study Edge so you can trust them, Teachers can be trusted too.

[For Algebra Nation] Once a class, an entire class period, could be a third period algebra class, reaches 10,000 karma points in total, they get a pizza party. Once ONE student gets to 5,000 karma points, they get a gift card. Like a $10 Target gift card or something like that. Then also at the Teacher level, whichever teacher has all of their students across all of their periods, wins a cruise or something. We're doing it by individual student, by class period, and by teacher as well [12:30]. So students can become like a wizard, when you get to like 1,000 karma points, you get like a little wizard icon that appears next to their names. When you get to like 10,000 karma points you could get something next to your name that says something like ‘really smart guru’ so people can see that they've gotten to a certain level. You can have games and prizes and awards that come along with karma points but optionally advantageous is really the trust system, how much you can trust someone, without just saying they're a wizard or a guru, our system is more complicated than that. That and the rewards systems, which is an incentive system based on total KP's that each student earns but it's also aggregated by class period and by teacher and also by school and by district. So we can have competitions between schools, whichever schools have the most karma points, because students select their school when they first come into the app, so we know what school they're at [14:14]. And then also by district because we know which schools are in which districts by looking offline, so we can also have competitions by district.

[36:26, revisited Karma Points] There's a leaderboard by month and by lifetime. We can also give out prizes not just off of total karma points but by a certain month. So from March 1st to March 31st, that would be a period. Or a year, or a semester. So we could do it based off of how many karma points have been collected. So the leader board tells you who's on top based on school, based on whatever, all based on how many KP's you have, but there's tow leader boards. One by month, and one by lifetime karma points. And we give off prizes based on that. And again only the moderators can give out karma points.

11) Special Admin Tools—The idea of admin tools is certainly not exciting, but there are certain pieces of it that might be interesting, like tracking people's facebook activity iPhone vs Android and then collecting data on like, the more students that watch on iPhone, the more likely they are to get better grades vs Android or something like that.

12) Protecting Students [15:09]—the way we protect students' privacy, for high school kids on the Algebra Nation project, is students can see each other on the Wall, which is a fake wall by the way, we built that wall it's not a facebook wall, it's our own custom wall, but the students cannot click on each other. They can't message each other. They can't click on each other's profile/or friends each other. it looks like they can, but we can control the rules on our planet in the facebook universe, so students can't actually click on each other. But the moderators can click on students' profiles just like normal facebook walls. Also, it's all limited based off of facebook's privacy settings. If a student hides their name on facebook, then their name would not be shown on our wall. If a student hides their profile photo, then it wouldn't be visible on the wall. Most students have those things open, so it'll show on our wall, but then they can't click on each other. Moderators can also look for bullying. [16:27] Also the fact that it's a transparent Wall and all open, and there's only one wall for all of algebra. One wall for algebra, one wall for chemistry, one wall for financial accounting. So one wall means you can see everything in one place, teachers can see everything in one place. So each classroom does not have their own wall, the way that it works on other websites, which is optionally advantageous to compare to others, edmoto or engrade, they call is a discussion board, but ours is one wall. By using real social media login, we piggyback off of facebook's protections because facebook has a police force that gets rid of fake accounts, gets rid of bullying, kids can report each other's activity. Because they're using their real identity, we also limit them based on the number of friends. For fake accounts.

[45:30, this section is also below] Study Experts we can change their photos. We can override their photos so it doesn't have to be their facebook profile picture. We can actually override anyone's photos. We can override inappropriate student photos, which is actually part of protecting students.

13) Textbooks and folders [20:00]—the idea that 10,000 schools in the country are all teaching financial accounting differently, but there's only so many textbooks, so what we do is record 80/20. The 80% is standardized, if you know what textbook they're using, we make all the chapter folders based on that textbook, then we copy and paste those folders into a school that uses that textbook. That's the 80%. The other 20% is stuff that we record on the fly. If we find out on the wall that one teacher is doing something different, we jump in the studio and record it or pull videos from our library. 20% is professor specific, 80% is stuff we can do before the semester even begins, because we know what textbook they're using. If a teacher says in class that they're skipping a chapter, that's fine because everything on the app is listed by chapter, then students will know not to look at that chapter on the app. So we know what teachers are doing based on the textbook, but we can adjust. If we want to hide a chapter from a school, we can do that. Or students will just know to skip it. So we can remove a chapter, but we can also copy and paste an entire series of folders for different schools. So we find out what textbook a school is using before the semester, put our folders up, and adjust as needed. Also, we use the chapter order from the textbook. We're not actually using anything from the textbook except for the order of topics and whether or not something is being covered. So that's textbooks and folders right there [22:14].

14) Scam eliminations [22:15]—Some kids share accounts. The first line of defense against that is the 50 friends limit. Everyone gets 10 tokens to start. Every facebook user ID. But we don't want people setting up fake facebook accounts and using those free 10 tokens that way. If you go to watch a video on one of these fake accounts, it'll say “sorry you don't have fifty friends” and you won't be able to watch. Some students will go away, others will just try and get fifty friends. So they'll take their fake account and friend 50 people. Those people can use their 10 tokens, but when they go to buy more after they run out, they'll get an error message that says “Sorry, error code number 1. Please call customer service”. We don't tell them what's wrong but something's wrong. Basically our internal rule is that if they don't have at least 100 friends, they can't buy stuff. When they get to 50 or 51 friends then try to buy something, they think that we got them again so they go away not realizing it's a hundred friend limit. Also if we see that a facebook account is watching two different classes, like Chem 1 and Chem 2 at the same time, then clearly it's very possible that they're scamming. That it's two students sharing that account [23:35]. So we want to get rid of those scams of those people scamming. Or if they're watching 2 videos from two different schools, that's another way that we know they're probably scamming.

Also, we give an 8 hour window for students to watch videos again without taking any more tokens (so kids can go to the bathroom or eat or watch other videos and come back). 8 hours from the time you press play, which is recorded in the database. We tell the students that they only have 6 hours to just give ourselves a bit of an extra window, but we do 8 hours as well. That's helpful because if a student ‘oh I watched this video then another video’, we know it's not taking any tokens. Also, we can grab all the reports and check to see what a student is watching and when because facebook allows us to know what everyone is doing all day long [24:30]. The 8 hour window is also nice because a student can't really use to one night and tell a friend to use it tomorrow.

15) Students add themselves to the teacher's roster. Teachers don't have to go and upload their rosters. Teachers have asked ‘how do you know which students go for which class period’. When students first enter the app, they have to enter their school from a dropdown (which can be changed), they also have to choose their teacher and class period. All of their wall posts and things that they upload is all tracked by teacher/class period/school. Students are linking themselves to teachers and schools [18:27].

16) Mobile—First of all on the Wall, students can take photos of what they're working on, like their math/proof that they wrote out, and post it on the wall. We haven't seen that anywhere. We're letting them take a photo of what they're working on because redrawing on the screen, we have a Draw Something too, but drawing is really difficult. You can just write out your work and post it on the wall. And someone else can take a photo of their work, and post it on the wall. Or other kids can take that photo, draw over it what's wrong, and post it back on the wall. Or, the tutors can just type out an answer back to them what they did wrong, or the tutor can Draw Something on the wall for them, or the tutor can take a photo and post it on the wall, or they can post a video [25:38]. So the tutor can type back, draw on the student's photo, the tutor can take their own photo and post it, the tutor can Draw Something back, or the tutor can do a video back (in the studio or with a video). So that's mobile. It's helpful because when you're studying or at the doctor or something like that you can be asking questions on the Wall. You can also watch your videos and open your PDFs.

Just being mobile doesn't make it exciting, but mobile does open up certain things like photos for example. You can draw stuff on the screen with your finger and it's a lot easier to do on mobile than with a mouse and keyboard, so that's helpful. Blackboard has its discussion boards, but they all suck. Also like symbols, if a student wants to enter something like a radical sign or a square root sign or an exponent, you can't do that on Blackboard, and they've been around for fifty years. On our app you can click the word ‘Symbols’, it gives you the option of symbols, and it puts the symbol into the little text area where you're typing.

17) Fake accounts—Facebook knocks them out, but also what we can do is the friend rule [19:05]. We can prevent anybody who has less than 10 friends or 50 friends or 100 friends from using our stuff. So if you have less than x number of friends, which is info we can get from facebook, we can say “sorry, your account looks suspicious, go away”. That's actually really helpful, that's part of transparency and protecting students as well from random people and bullies and stuff like that. Also, for protection, we could give out a password to kids who put in a certain teacher/certain period where all the kids from Ms. Smith's 3rd period class get one password, and they have to put it in to be verified so no one else could get in [19:42]. We don't do that now but we could.

18) Video Views—We can track video views not just by what they clicked on but by what tokens they use, how many times they just played the video (even if it's not taking tokens), we can check by subject, by school, by individuals (see all the videos and PDFs a person has watched), aggregate reports, what time of day videos have been watched, supplement video views. We can also tell which practice problems are the hardest based on the video views [28:25]. We're learning how people learn based off of which videos they watch more, how often they watch those videos, whether they watch them again, the order of videos watched (going back and watching a previous related video after watching a video. Also, videos can be rated 1-5 stars. Students can also post on the wall and make comments about specific times in videos (“I don't understand 3:26 of the video on whatever”), so we collect that feedback, and we can replace videos as well. We can keep the video views, if we re-record a video to make it better, we can just take one video out, flip it with the other, and maintain all of that previous data for that video (how many times it's been watched), and continue the data with both the old and new versions [29:15].

19) Content Protection—Some videos take 1 token, some take 4 tokens or X tokens based on how long they are or how important they are or how much demand there is for those videos. For the monthly memberships, it just recharges their tokens every month so that way the tokens don't roll over and it encourages the students to study more. [30:08].

We have our own payment system on facebook that doesn't go through facebook credits and facebook payments, but linking that to real accounts so people can't share as much. So by putting the payment system into facebook and linking every transaction to a unique user, we know who the users are at authorize.net [30:43] they're the ones that run the credit card payments, but we link that to real facebook users so we know who they are.

[42:46 revisiting] On content protection, a lot of students just want an answer key. But what we do is we force them to watch videos, because the videos burn tokens, so you've gotta watch the videos to see the solutions. We don't just give an answer key, which could be one token or zero tokens to open up the answer key. We actually make them watch the videos of each practice problem. That way, students who watch less practice problem videos pay less, and those who watch more and consume more, pay more.

[Second video, 7:52]: We also obscure all the file names. What happens is we upload a file that has an index code for us, like chapter 7 University of Michigan, textbook, but then when it goes on the app, it changes it to a series of different numbers and letters, so if a student downloads the pdf and saves it, they can't go back the next semester and see what it was very easily. They'd have to rename it themselves. When they email it to friends, they friends won't know what it was. We also set it so that there's no copying allowed on the pdfs. We password protect them to open the PDF, so if a student gives his friend the file, he also has to give the password that goes with that PDF [8:34]. We also have tokens from Akamai, different tokens for password protection. When someone presses play, it gives them like a one second authentication token from Akamai to get the video real quick to deliver it, so the student can't just copy and paste it to their friends and all watch the video from the same stream.

20) Speed test/Video Player: [30:58 We have a unique speed test that basically gives a red light, green light, or yellow light saying how fast your internet is, and then that disappears if your internet is okay. It comes up and shows you if your internet is red or yellow and it's slow, so users don't just call up customer service like they used to do and then we'd find out it was just that their internet was slow. We've got our own built-in speed test right next to the video. [31:32] So for the video player, we've got the Next and previous options underneath the video which goes and reads through the folders [on the app] but it'll jump folders. If you were at the last video of Folder 1, it'll go to the first video of Folder 2. It'll jump back and forth between the folders.

21) News Feed [31:59]—When you post stuff on the Wall it goes up on the facebook news feed and then people can see what other people are asking about, what videos they're asking about, and they can click on it and it brings you straight to the wall. And then they can ask questions related to that.

21) Keep Me Informed (KMI) [32:23]: This is part of the whole process of keeping them learning. Students can click the Keep Me Informed Checkbox [right above the video player on the app] for financial accounting or for chemistry or for whatever and they can keep informed on whatever subject they want. Or Algebra Nation. Keep Me Informed does two things: 1) it gives us their email address, so we can email them if we have updates, like if we post a new video we can email students, it's like being on an e-mail listserv. But also 2) if somebody posts on a thread that a student has posted on, then it'll send the student an e-mail. They don't have to go back and check the Wall and see if they got answered. They can just check the KMI box and subscribe basically. And it works for each thread, so if they're the first post in a thread or they made a comment on a thread anywhere, KMI says that any post that I'm on, if someone posts after it, it'll send me an email [33:11].

23) Check-in/Check-out [33:28]: It basically says that students can check in or check out of the app, all it does is show up on their facebook news feed basically saying ‘I'm checked in to the Study Edge Library, leave me alone, don't bother me’, and then they can check out and it basically says ‘okay I'm back in facebook land you can talk to me now’. It's a marketing strategy.

24) Algebra Nation Calculator/Practice Tool[34:00]: On Algebra Nation it works the same way except an extra piece of the learning is that students can try practice problems in an online environment that looks like the actual End of Course test that they're actually going to take. The idea that you take practice problems and you go through ten problems and at the end it tells you which ones you got right and which you got wrong, ten problems for each section. There's eleven sections, each one having different concepts. Each one has a Test Yourself thing, you do the Test Yourself, you go through ten problems, it tells you which ones you got right or wrong, it's got video solutions for each one you got right or wrong, it also points you to the concepts that you missed, and tells you to go watch those other videos [34:39]. The calculator is on the screen, so students can get used to pressing the mouse and the keyboard buttons which is helpful, so that's part of the learning process. The learning process is: your teacher assigns you homework to do Section 5, or you just decide to do Section 5. You watch all the videos, you print out the study guide, you follow along, then you try the practice tool, you try the ten problems, it tells you what you're getting right or wrong, and then you can ask all of your questions on the Algebra Nation Wall along the way as you're watching the videos and doing the questions and stuff [35:05]. And it's all on one screen together. Or other students, who just want to learn everything from scratch, or parents want to learn algebra, they just go through all eleven sections, all of the folders. Watch every video, print out every study guide, all the way down and try the practice stuff all the way. And they can ask questions on the Wall all along the way. Other students go on Algebra Nation and all they want to do is ask quick questions about their homework, so they just take a photo of their homework and post it on the wall. Then other students and moderators help them.

25) Activating Schools and Classes [35:49]: That's a little bit of a smaller piece of this but basically we activate a school if we're ready to do some content for a college, like the University of Michigan, and then we can open up financial accounting, we can open up chemistry, whatever we have we can put content up for that textbook. As we go and have that textbook covered, we can put that content and open it up.

Organization of the app itself [39:22]. Content is up top, and below is the Wall. So the top is the videos and documents section all in folders, and down below is the Wall. So up top [the content] is static, and down below on the Wall is the interaction with students and moderators.

On mobile it's left to right. On the left there's a tab for Videos and Documents, and on the right a tab for the Wall.

The direction of the videos, how to go through them, is in folders. [41:04] Like Chapter 1 goes before Chapter 2 and Chapter 3. But even within chapters it's section 1, section 2, section 3. And then in a section it's video 1, video 2, video 3. So there's a massive amount of content, and the way we display that content, is as simple as it gets. It's videos with a study guide in a folder (and maybe for Algebra Nation the Practice Tool is there too). Then a practice problems folder. And then the next folder is videos, a study guide to print out with all the video content in it, and then a practice tool/practice problems folder. And then down below, we've got the wall and the interactions and stuff. It's top to bottom. It's like learning top to bottom on a web page. It's not like reading a New York Times article and just reading it in order, this is different content all over the place, but the content is all in order. It's not Videos, then documents, then whatever [separate sections]. It's what you need to do in order, separated into folders. There are also announcements [shown in the video app tour].

[43:25, the Buy Now page] So we have the group codes, discount codes you can put in and 10% is taken off, another 10% is stored based off of your user ID. So you put in a code, it takes 10% off at checkout, but also an additional 10% is linked to your user ID, actually it's not linked to your user ID. So you give out a code to a group, say a dormitory. So all the students in the dorm use the code. Every student that uses it, gets 10% off. They're incentivized to actually put the code in. Plus, an additional 10% is associated with that dorm. So that money can go to buying them a ping pong table or something like that. But there has to be one student who can see how much they've earned [44:03]. We link up that code to one user ID, so that student can see in their My Account page exactly how much has been earned for that code. They know what's going on and it's transparent, and they don't have to call us everyday asking how much their dorm earned. And then, when the next person's in charge of that dorm, when the next dormitory president is in charge, we just switch the association to that next person's facebook user ID, so that they can see all the people underneath them. So it's a referral program that moves and every month, those people are saving 10% and also 10% is being set aside for that group. [44:40]. But the next president can see all of the people below them.

You can also use facebook, like if you want to say who referred you, you can type in your friend's name and if they're a facebook friend of yours, or it's somebody who's accessed our app before, it'll ‘automatically’ type their name for you [autocomplete kind of thing], then you click on that, and it'll give that person $10 cash back for referring you.

[45:30] Study Experts we can change their photos. We can override their photos so it doesn't have to be their facebook profile picture. We can actually override anyone's photos. So we can override inappropriate student photos, which is actually part of protecting students. Also, students can't delete other students' posts, but they can delete their own posts. And any moderator can remove posts from students. Once an admin has posted on a thread, a student can't delete their post any more.

So if the moderator answers it, it's like we're creating a textbook, we want a student to be able to read that. If a student is like oh okay I get it and delete their post, well then we'd lose our post, and other students can't read that and understand it. Our wall is built to help everybody no matter what. But by reading other students' questions and answers, and the content is constantly building and creating itself, we're basically creating more content every day. It's constant content creation and it's part of the learning process. [0:52] It's the whole learning process, which is a student goes on there, they watch an intro video, and they go through individual folders, whether they watch short concept videos, individual concepts that they're confused on, and they watch that individual video, or if they go through the whole thing watching all the videos with the packets. That's another part of the learning process. Then there's the Wall, and how they interact on the Wall is that they ask questions along the way, and we have all these protections on the Wall.

[1:45] We index every practice problem, every short concept, every chapter review. So if one textbook has Chapter 6 for straight-line depreciation, and another textbook explains it in chapter 7, we can just take that video and use it for both (in the video we don't say what chapter it is, if it's 6 or 7 or whatever). That exact same video can be used as Chapter 6 or Chapter 7 for either book. Or if both books go over a lot of crap in that chapter, we take the lowest common denominator, the material that's actually covered in both, we do a Part 1 video that works with both schools. And then we do a short video, Part 2 for one school, and Part 2 for the other. They're shorter videos, and different Part 2 videos for each book. That's part of our indexing system. So everything is indexed, and then we can use stuff across classes, because some classes use concepts from other classes. Everything is indexed with that code, and that code is used in both places. Because we have practice problems in a chapter review and then we also have practice problems in the short concept videos, if a student says ‘I'm on problem S1’, we know that S1 was from a short concept video, and our staff and look up the answer real quick or if they say P1 we know it's from practice problems number 1. Or if they say C1 it's from the Chapter review, problem number 1. [3:05] So we have chapter reviews, which are like an hour long, short concept videos, which are like 10 minutes long, and practice problems, which are like 5 minutes long, 5 minute solutions or whatever. Explanation videos. And there's a reason for those lengths of the videos. Some students want a review of the whole chapter, and make sure they know everything for the test. Short concepts, though, are just used for looking up bigger concepts. A student is trying to do a problem, they don't remember what to do, they look up one concept video, they get it, maybe try some of the practice problems online, ask questions on the wall. Then go back and do the homework problems for themselves. If a video is less than 3 minutes, they don't find any value in it, they wonder why they used a token for it. If it's more than 15 minutes, it gets to be too long for the short concept video and it's not using enough tokens. We don't want to have too much content in there [4:07].

[On the topic of back-end folder structure]: Just the idea of moving folders around between schools, associating those textbooks with those schools, and being able to add the 20% later.

[4:46] Also with our memberships, $25 a month is silver, $50 a month is gold, one just includes more content than the other. And also in Gainesville Fla. they include coming to live sessions as well. So as part of out tutor training and our process overall, we give our sessions live then we jump in the studio already knowing what the students understand or don't understand, and know how fast or how slow to talk based off of how fast the students understood it in the live room, then we jump in the studio and record it there.

[for Algebra Nation] Also both a, short version, and a fast version. But then also, guys versus girls, cause some of the students relate to a guy or a girl, of those different things, we have two different sets of videos for them to relate to.

[6:04] For the video/studio stuff, there's the PIP, self-recorder, no post-editing, two camera angles, transitions (Study Edge tips, etc.).

[7:00] Also, there are Bio videos about tutors just for trust. On the Wall there's a little button students can click and see about their tutor, that they're really smart, they were on the math team and that kind of stuff so that's really helpful. It's making our own facebook custom wall, and making it look like a facebook wall, so that the students are like ‘oh I'm just posting happy birthday on my facebook friend's wall’, to get that look for them so they feel comfortable and fun and social and not thinking it's too much school.

[For PIP,] With PIP we can make eye contact with students, not like a professor lecturing at the front of the class. Professors and teachers turn their backs to students to write on the board which is avoided with PIP. There's millions of educational videos online, and no one's done it right, so it's not obvious at all.

Also, our tutors wear the same shirt every time, keep nails and hair the same/being clean shaven etc. That whole process of keeping the videos similar [appearance of tutor] so that videos look like they were all recorded at the same time. If students are watching videos in a row, they don't get distracted with differences in tutor's appearance. It looks more like the videos are actually prepared for a particular student rather than just recording different videos over the course of two years. Random videos on youtube don't look customized, but our videos do. We can take videos made for different schools, mix and match them, and it looks like it was created for that one school. But it wasn't, it was created over many months, it was just put together in that order that's needed for that school. But it looks continuous.

[More possible stuff for the studio tour, 11:00] Mic, spotlights on the paper. The poll that has the camera easily movable up and down.

Video 1

Much of the management and data collection on users in the app relies on facebook's user identification number (UID). We use somebody's Facebook account to access the application so they do not have to create another username and password. This makes it simple for our users but also simple for our staff and others because they work and do things where they are everyday—Facebook. Also we do not have to worry about people sharing their password or having to create new staff accounts and passwords. A user logs into the app and they are the bottom level access. All they can do is login, we know that they are new on their app by their Facebook UID so we give them 10 tokens to try videos/documents free of charge. They can also write on the wall to ask a question to a tutor. If they would like to buy a membership or other tokens they can do this and we assign it to their UID. When they write on the wall they can ask questions or answer other people's questions. We also assign karma points (see later section) to a user's UID. We also assign karma points (see later section) to a user's UID which should entice them (since we give out prizes) to answer more questions and post good information to help us gather the 20% professor specific material we need (see later section).

Inside ‘manage access’ (a feature within our application located under admin tools), we input the UID of a user that we wish to give admin tools access of some kind. We have a couple of different levels of administrator/executive access including customer service, study expert and staff, executive, and teacher. It works in a totem pole for the first three. Customer service has the lowest amount of features they can do within the administrator/executive tools. Above that is study expert and staff who have a few more capabilities but they can also do everything that customer can. At the top is the executive level who can do even more and everything that customer service and staff can. Teachers are different because somebody who is denoted as a teacher in administrator tools is set for a specific school and they get special reports built for them. Anybody who has executive administrator level access can access these teacher items as well. Any time that a user attempts to manipulate the app's interface or utilize its higher functions and administrator tools, the app cross-references that user's UID with the list of UIDs that have been given administrator privileges to grant access to the user.

The above paragraphs explain how we add administrators but we also denote these administrators to all of our users on the applications. Not only do users who have different level of administrator access have different rights within the application including being able to upload new content, assign karma points on the wall, edit the application, etc. but they are also clearly seen by anybody who users the wall feature on the app. On the wall if a user has certain access they receive a box around their name along with a title such as Study Expert. This helps us show the differences between a regular student answering a question and a study expert answering a question. Ideally students would see the study expert answers and could comfortably presume those to be correct since they are coming from our trained staff. We do this all on a wall that we custom built to look like Facebook but to have little small changes like the blue boxes and different background texts for those who have administrator access. There were people who needed admin access in customer service but who did not need to be denoted differently on the wall since they were also using our service so we also have a feature built where they can use the admin tools but not be seen as experts on the wall. Note there are many different forms including teachers for our highschool programs, study experts, study helpers, etc. who are all denoted differently on the wall.

Admin Tools Features of Interest

Many of the functions are reports on users' activity within the application. We use this for a variety of customer service reports, tracking our users, tracking buying history, looking for fraudulent/sharing/scamming activity, and being able to track our customers on a variety of levels. Keep in mind what it is in admin tools are what we have programmed to allow non-programmers to access. We track or could track even more on our side including how long users' leave the application up, how many times they pause a video, number of times they access the application in a month, and this list is as long as the number of features/actions/capabilities within the app. A few things again that we track and have our staff look over in the admin tools users simply clicking on items or them amount users are watching a particular video, when they're watching it, how often they're watching it, how often they're buying tokens to watch videos, how many tokens are being spent on which videos, and how many subjects a user is watching (plenty of other data mining features). Tutors love the aggregate report capability so they can see how many videos are being watched by students in their class. It gives them instant feedback on what videos are “working” Reports are also available to download in excel format and many of them are also available in web format so tutors and customer service do not have to download the reports (waste time) but can see them right there for quick action and helping out people. The “duplicate” feature is particularly interesting because it allows us to replicate a folder that contains all the content (videos and review guides) that has been arranged for a particular textbook into other schools that are requesting that material.

80-20% principle: Manner in which the system is alerted and to and/or can log that a teacher-specific 20% “deviation” has occurred

There is no automated way in which the system alerts us to a 20% professor-specific deviation at this specific time. Just to explain again 80% is the textbook and then the other 20% is what we learn either from previous years teaching that professor university or information we learn from students that makes it more specific than just the textbook and we denote this as “professor specific.” We refer to the 80-20 rule to explain where we aim to be on the spectrum of only having information in the textbook and having professor specific information. We want to be somewhere on this spectrum. Doing 100% teacher specific would be ideal but is impossible because that means we would have to record a video for each different teacher at every university every semester. Doing 100% textbook specific would be easiest but doesn't privAfter we explain the concept we will tell you a couple of ways the system could work. We are often notified of such deviations through posts on the wall by students as they ask questions or just give us information about the class. For example a student might write to us, “Hey in class today the professor told us that chapter 6 will not be on the test.” This way we know not to over this in the review making this more professor specific. On the other hand a student can also say, “The teacher really harped on chapter 6 and uses a Y instead of X like the textbook.” We can then record the videos specifically for that school and even say things like, “I know your textbook says this but your teacher actually says y but just so we all know it is the same thing in these types of problems so don't get confused when you see it differently on the test compared to your homework.”

We could have a checkbox breakdown of topics via survey that a student could fill out in coming to the app which is then processed by the app to indicate to the moderators which of those topics the professor plans to casually cover. Also as we post videos in the backend we could denote whether these videos are professor specific or textbook specific. We do this already with our index of practice problems where we organize all videos we have ever recorded. In the backend though when we upload a video if we designate professor specific versus textbook then we could even show a percentage to students so they could know how well our material relates to their teacher versus the textbook. Also some videos are professor specific but could also be done in a way that could be used for other schools.

The app can recognize if two instances from the same UID (aka same Facebook account) are accessing the app simultaneously. When the app recognizes this happening a couple of things happen. First the app stops sending video to both streams. We recognize that we should not stop all streams because some people leave their computer on at home and then go to the library and a video might be paused or even running so we do not want to make users upset. Instead all we want to do is stop both streams to prevent sharing. Also the app flags accounts that watch 3 or more subjects within a span of 30 days and automatically prevents access of their account until they contact customer service. We do not this because there is a very small chance a user would be watching three subjects because for the type of classes we teach it is just about impossible for them to be in all three classes. Thus they must be sharing their account which hurts our bottom line and this is our way of preventing it. If they are part of the very small few we do have a method of first having them either show their schedule or prove that they are indeed in all of those classes and need to be watching those videos and then in one of our admin tools we have the capability of removing block since they have proven to us they should have access to it. Other security features in place limit access of the app to those who have fewer than X number of facebook friends to prevent fake accounts since students may be unwilling to share their facebook accounts with other but might setup a new account since they are free just to share with other. We do not tell them what the error is but it simply just says ‘Error 1045 Contact Study Edge at . . . . ’

“News Feed” Discussion

As users explore and use the app, actions such as posting on the wall, watching a video, buying/upgrading a membership, buying tokens all trigger an event on that user's Facebook account. We use Facebook social graph within this which is specifically designed for Facebook communication between your app (like Study Edge) and a users' (our students) timelines and their homepages. The best way to see this is in screenshots we have attached but know that for almost any action new can create an item that then appears on the wall. These items can spread quickly on Facebook. Somebody starts using the app, then their friend sees their newsfeed and sees the app, and then somebody else and all of a sudden they can become aggregated on your home page like: 55 of your friends have started using Study Edge for their class.” This newsfeed traffic is interesting because it gets them into our app and then they can try things for free. Even if they do not use our application for whatever reason we still piggyback off of them clicking on us and us going to their newsfeed. Some companies do this well but we are different because we then can track all of this information, see who click from who's wall, who is friends with you, and begin connecting individuals into who to target and offer discounts in the hope they will purchase or simply advertise to at full price. We can also evaluate our marketing people and interns on whether they are doing a good job in a specific region, school, or the number of people who are viewing are application. We have also thought of a few incentives for people to tell their friends including if you connect 3 of your friends to the application and they purchase a membership your membership becomes free. Currently if you tell a friend you get $20 and is all done on Facebook when they purchase a membership. We could easily track from who's newsfeed and reward that person and create a pyramid system so people are posting about us more and creating a buzz on their university about us so they could earn money, more Study Edge tokens, karma points, prizes, etc.

We refer to content to mean many different things in our company. Content includes any review sessions recorded, practice problems recorded, supplements recorded and all other videos along with the actual written out in PDF, TXT, Word documents of those problems we answered via video or study guides or any other text that we might have produced . . . In fact . . . Anything we produce for a class we consider content. Classes at different schools for the most part use different textbooks. Some schools use the same textbook. So for example University of Michigan and University of Indiana chemistry classes all might use the same McGraw Hill textbook edition 12. While other schools like Arizona State University have 12 different sections (a section is taught at different times and a lot of times by different professors or graduate students) of chemistry . . . . Some of the sections use McGraw Hill edition 7 and some use McGraw Hill edition 2 and other use a Pearson textbook edition 3 and a Pearson textbook edition 15. Every school does things differently. We picked out the classes to offer initially at schools around the country based on what textbooks were going to be used and how large the class would be. It doesn't help us if a school is using the same textbook if there are only 3 kids taking the class because only 3 potential buys. Our initial goal is to simply record content for an entire textbook. We want to teach the textbook at the schools we choose by recording all content relating to that textbook.

How do we upload this content to the application? When “we upload content for a textbook”, we are arranging content (videos/documents that we have recorded in our studios for a particular topic that is located in a particular textbook) on the app in such a way to deliver the content for that textbook that explains the material even better than the textbook does. We have thousands of practice problems, concept reviews, and PDFs that we have created. We put these up on the application first based around what I in the textbook. Calculus for example at the University of Miami we might use all of the videos we have because all of our videos cover 100% of the McGraw Hill calculus book edition 2 and we need all of those videos. Let's say the Pearson calculus book is used by University of Florida and it only requires 80% of our videos. So we may only put 80% up. Additionally different textbooks go over things in different order so we have to put things up differently such as the order of the chapters or even different usage of the words ‘average’ and ‘mean.’ Then on top of this we apply the 80-20 rule (see previous questions relating to this) to put up even more specific content. The goal is to have our material more organize and the users see the information designated to them. How this actually add the content to the app is best seen in the screenshots in the other attached item.

“Obscure Filename” Concept.

We want to prevent sharing of our content. PDFs are protected by renaming the file to a random string of 10 digits .pdf. We upload the on the application and the application places it on our server. Once on our server the application gets rid of the previous file name (that the tutor had put on it) and instead renames the file with a random 10 character alphanumeric string for the filename. This helps prevent sharing since if student 1 asks student 2, ‘hey can you give me the packet you have from last year?’, then student 2 says ‘oh crap, I can't figure out what file it is because I searched my computer for ‘financial accounting study edge packet exam 2’ and nothing comes up. I have some files with random characters, but I don't know exactly what they are.’

In the studios we have the content that we are writing on the desk in front of us. It is also being projected up on the monitor that is behind the camera that is recording us so we look at the problem we are referencing instead of having to look down at the paper in front of us. This makes it easier for us to reference, looks better, but also we show students that we really know the subject matter and a lot of times students think we memorize the material since we look away from the material.

On video it is very hard to keep the user entertained. We of course do jokes to keep them entertained. We switch between camera angles of us as a face cam which is our waist up and then we have a doc cam view which is what we are working on. We also have picture in picture which we use all the time to keep “eye contact” with the user even while they are working on problems it makes it more personable.

An embodiment of the invention, as illustrated in several of the screenshots included in this application, may be referred to as Algebra Nation.

In an embodiment, and Algebra Nation session begins by showing a logo, and goes to the ‘face cam’ so the user feels welcomed. Then the tutor sends it to the picture in picture shot, just by clicking a button off-camera. It's seamless.

Notice the tutor shows animation, and then does it on paper, on the same back green screen, so you can see it on a computer (animation), and then also how YOU the student can do it with a pen and paper.

The tutor looks at the student at all times. Doesn't turn their back and face the whiteboard behind the tutor, like most educational videos.

We found a way to make it LOOK like it's been post-edited, or that there's a director. But there's no director. The tutor is directing at the same time. Part of it is by looking at the camera in the very beginning and very end, and using their fingers off camera to change the camera angles.

The tutor id in a corner, but the tutor could be in any corner. Or could be half the screen or ⅓ of the screen, etc.

And the logos, watermarks, are moved to another corner automatically, as you can see in the video. It's a slow smooth transition as the tutor moves from the full screen (face cam) to the bottom right (picture in picture) . . . so the user doesn't get vertigo or get distracted by the camera crap . . . but instead can focus on the actual learning. it's a nice transition as the tutor kind of ‘shrinks’ from the face cam down to the bottom right in PIP shot.

The logos are moved to the top right because the tutor looks the best in the bottom right. so we move the logo(s) to the top-right (when the tutor moves to the bottom right).

The tutor is opaque, not transparent, but could be semi-transparent so you can see what they are blocking. So if the tutor is writing something on the bottom right of the paper, and it's behind the tutor, you can still see it because it can be transparent.

Even with the tutor opaque (as it is in the video), we have more room around the tutor, like over their shoulders. That space would normally be lost for picture-in-picture, but with our green screen thing, the room above the tutor's shoulders is not lost.

We have other videos where the tutor is 50% transparent so that the tutor is visible but you can also see much of what's behind the tutor's body.

Points System in GIN

Sororities and fraternities have a system where they record points to measure different aspects of their members' involvement. There are many different ways to do this within a chapter. You can use them as a sort of an award . . . an award policy type thing that these individual organizations have so that you have a certain amount of points you can go to this event . . . and then some chapters also use them in negative light. So, lets say you don't attend events . . . we'll put that in a negative light that you are getting points and that's a negative thing for the chapter. Then they can't go to additional events. So, it either can be a positive thing or a negative thing for members to receive points.

Just to kind of reiterate groups use it as a reward system or as a penalty system. For lot of groups . . . use it to encourage users to attend things . . . they make sure . . . in order to attend formal, you have to have 20 number of points and you earn those points in a variety of different ways, attending community service events, attaining community service hours, meetings.

They can start off with let's say 100 points and if they don't come to x amount of community service events, they get 3 points taken off, and if they don't have x amount of points they cannot attend certain events, or be rewarded in other ways for their chapter.

I've seen examples where people earn points by buying t-shirts for their organization.

You can buy t-shirts, tie in with community service and philanthropy, attending chapter meetings.

Some people use the points system to track service hours or study hours if they don't have a pre-set point system. They have to go to the GIN and they can track how many service hours they've done, or community service hours, or study hours just by using that printable sign in sheets that they have here.

Also it can be set to two points so either attending other philanthropies put on by Panhellenic or IFC organizations on campus that they get points for that.

Also some groups use it if they attend or are involved in other activities on campus, so if they're in any leadership roles, or if they're just in another organization on campus, they use those points which also, filter up to their national organization, in the sense of receiving criteria for awards on a national level, and then also a lot of them use it for intramural sports, also finances—if you know say that they paid their dues on time, then they might get 5 points for that. Paying dues on time is another way that chapters are positively giving points.

That way the national organization can document how many service hours a chapter does per member, how many philanthropy events, how many of anything they can possibly imagine, that information can feed up to the national organization and then can be documented. The same thing if you wanted proof of documentation for an internship and how many hours you've done tutoring, all of that could feed up to whatever organization chooses to share that as proof in documentation, on your FB wall, anywhere. GIN is where all your points are and you earn points, and someone in your chapter is in charge of giving those points toward what we're about to talk about, and that person kind of validates those points, so it's kind of proving that you've done x-y-z event instead of just writing them down on a sheet of paper.

Also, another example is ritual. Most if not every single organization has their own ritual and a lot of chapters choose to use the point system for their ritual to either, you know, have people come, or give special circumstances if they can't be there, if they have enough points they don't have to be there.

Basically these chapters make a point system to enrich their chapter life so that these members get the full effect that comes out of greek life. Instead of using messy google docs or excel spreadsheets, they use GIN so it's all in one place for these chapters to utilize their point systems.

And that's probably perfect, so groups have always had point systems in some capacity. Through GIN, not only is it online, and so not a google spreadsheet or not just an excel spreadsheet that's passed around from computer to computer, but it's something that's more living and breathing and that's kind of what we're going to talk about, about how this system is all combined. Our system is the only system that has positive and negative. Normally one or two people in the chapter is in charge of the points. This person is an administrator in our system. They have certain privileges that they can do. One of those options inside the “My Menu” is the ability to manage points. Every user can go to their point section.

And in the side Manage Points—that's where we're going to go to first. Who normally gives out points or who could give out points? Who are all the possible people that could give out points.

Sometimes a chapter has an actual points chair so they might have a points chair in the organization, they might have their chapter secretary in charge of the points, chapter treasurer, president, vice president. Basically anyone who has administrator access in the GIN system they're telling them—okay this person shows up in administrator access and one of the things that they can do is manage the points system.

You can select one person to be in charge of points specifically on the GIN so that when you go over the appeals that one person will receive that information.

In our system right now its all administrators can receive points, but we talked about the idea that you can make a specific chair, so that it's a totally different position. Also we've talked about the idea that you can just check off the box next to someone's name on the manage users screen, and next to the manage users screen, there can be a checkbox that says this is points administrator. That way this person is the only person that's allowed to give out points. The reason why that's so optionally advantageous is because as you can guys kind of heard, these points are optionally advantageous for a lot of these groups. We also archive the points, urn, year to year, so that way at the end of four years, members can see all of the points. We archive the points into our servers and save them so the chapters can see them, but in four years you can see how many points you have. And that kind of goes back to the whole process not by just being inside of any organization, but she actually can use that as a resume builder.

Also we can export those points, from a more programming side, we can export them and also move them over in the points section how that chapter member connects on a chapter level.

And the idea has been brought up that you can share the points for the chapter, so you can share to an RSS feed and then put it directly on the chapter website, so that way the points are public, you can kind of share that information, and make it a fun game so everyone can see. It may be points for just specific events, it may be bringing somebody to a philanthropy—you can see who and that can go up on the website.

Let's first start off with the points screen itself, so My Points under the My Menu.

You go to My Points, you'll see that there is a My Total Points and so you'll see there that that's the amount of points you have total. You'll also see the percentage of total points that you have out of everyone in your chapter. You'll actually be able to see a points breakdown of each event, and then each point possibility under each point tab. So let's say there's an Event's point tab, a Finance point tab, Scholarship tab, with different point possibilities under each of those, and you'll see whether you did or did not receive those points. And then you'll actually get a rank of your chapter. So let's say you have 80 members in your chapter, and you're ranked 15, depending on how many total possible points that you have. This is also the screen where you're going to be able to appeal points if you wish to do so.

Let's break right here so we can think about the different gray bars at the top, the different sections, the Events gray bar #1, those like headers of different kinds of events, these are the group headings, all the categories of buckets, and underneath those are individual either events or individual items to earn points based off of.

You'll see that under your point tab say events you'll see in screenshot 1 under my points. Let's say inspiration 8/20 is this specific event, and you'll see 0 out of 1, this means this person did not attend inspiration 8/20, does that make sense?

And if you continue to scroll down you'll see that there's each of these different tabs has possibilities under each of them, and next to these possibilities you'll see what they did or did not receive points for that specific point possibilities.

Just depending the point possibilities on each one that the chapter insures when they're adding points in they put how many points each event is worth. So a chapter meeting might be something minor to them, in a scale thing, so like, a chapter meeting would be one point, but something like a chapter initiation is something that the chapter sees as members need to heavily attend, so maybe 10 so the more points—and also sometimes chapters when they're adding new points they might make something before an upcoming event. So say for example the chapter is having formal, and that's what the chapter members are working their points towards. For the events towards formal, they might start making their events more points, too. So also, a lot of the times, chapters do it on a large scale of what the event actually is, and the importance of it in the chapter.

And these can either be scaled or an all or nothing so if you say chapter is worth one point, and if you attend community service up to 5 points—if you didn't attend chapter it's a 0 or 1 whereas let's say you attended half of the 5 hour event you would get 2 to 3 points for that scale. So it's scaled or all or nothing.

So either all or nothing or you can earn partial credit and we'll show you in main section in a second on how to do it. So let's walk through what it means to appeal a point.

If a member goes to their My Points and they realize that they did not receive a point for let's say again an event that they did attend, you'll see next to the 0/1 points they can select the word “Appeal” and then you'll also be able to give a reason why you believe that you deserve points for that specific either event or point possibility. And so you can, once you write the reason for the appeal, you can actually select “Send Appeal” and when you do that, that may be sent to the person that is in charge of the points.

And also the appealed points depending on which one you look at as we said before there are two types—that you either receive all the points or partial points—so with all the points there may not be a drop down menu when you click on the appeals, it's just going to say that you are appealing the whole number of points. But on the partial points one you can appeal back certain numbers of points and there may be a drop down for that.

So that way if you felt that you attended that community service event for half the time, you don't deserve 0 points, you can say you deserve 2 or 3 points, you can argue with the administrator or the points person for those 2 or 3 points. Instead of saying I don't deserve 0 points because I attended, but I can't earn 5, you can have that middle ground.

And the good thing too about the appeals is that people might wonder, “How will we know that these administrators are actually getting the appeals?” Once the appeal is made a notification goes out into the email of anybody who has administrator access.

Those administrators may know that there have been appeals made under the admin which we'll talk about in the Manage Points section. There is a separate Manage Appeals page in which they go to.

Great, so now we're into the admin menu Manage Points.

We're going to go ahead and go to . . . Let's finish up appeals.

Okay so we just talked about a member could appeal their points. When the person gets an email, they'll want to go to Manage Appeals→Click here to view pending appeals

And then once there it's going to give you a full list of all of the appeals that have been made by chapter members, and on this screen you'll be able to see a summary including who that appeal is coming from, the contact information (just so that it is easier for you to get in contact with them), what the actual appeal is, so that actual appeal may show the title of the points, whatever that title was created in the points tab, and then once you click on to actually appeal it—you'll see there an approved or denied button as an administrator and then there's where you'll see how many points you're going to give back, or if it's 1 or none. And then you can also then write back the decision or any comments that you need made back to that specific member, and then when the member goes in, he or she may log in to her account and see a decision that has been made by the chapter administrator. So the whole time it does give you the overall summary of the details, which is great, so you don't need to continue to go back onto different screens and you can see the different information on one.

You'll see the resolved appeals area, the appeal or deny, and all the contact information at the bottom, and you can also send a reply.

And then also on the next one under the Manage Appeals there's a button that says “Click Here to View Past Appeals” so any ones that you have already resolved, we do automatically show you those here, and you can check on the status of those, so if there's any questions that member says he or she didn't receive this information, you can always double check yourself on the appeals that have already been made.

See Result Appeals. This is under the “Manage Approved and Denied Appeals”

To create these points areas whatever the specific chapter has created for their chapter they can add as many points tabs and points possibilities as they want. So under the Manage Points Area you'll see Add a Tab, and so say you want to an Events Tab . . . . So on the tab when you're adding a tab, those tabs should be like Main Events so Events, Philanthropies, Service, Social, Chapter Meetings and then the points possibilities should be those events or specific things that fall under each. For example, if they were to create Chapter Meeting as a tab, one of the points possibilities would be Chapter Meeting 2/23, Chapter Meeting 3/1—so if they were to create something as Philanthropy it might be Panhellenic Event or what not 3/23, so again the tabs are the main items, and the points possibilities are those specific events that fall under each tab.

So like we were saying it is really easy to create these points tabs and possibilities so as your tabs would be your main either events, philanthropies, finance, etc. Once you build out those tabs, you can actually add as many point possibilities as you want under each of those tabs. You'll want to select the name of that point possibility, so that if it was under the tab Chapter Events and you wanted to name the point possibility Chapter 8/23 you could then select the Score Type which is like what we said before—set amount, or it can be different amounts like the partial credit, or you can also have a max score. Then you can select which tab it goes under. So then you just build your points area with your tabs and possibilities.

Once your tabs and possibilities are created, your chapter may be able to see their My Points tabs with these tabs and possibilities and depending on how your chapter works whether you give them all of their points and they're deducted from there, or they all start with 0 points and they gain points by different activities and payment, the administrator in charge of points can actually go to Edit Points For a User.

You'll see that it says Pick Users to edit points. You pick the user and then you'll see all the points tabs and possibilities that you created and you can give members points as necessary.

So the next thing is this—the user can appeal but also if I make a mistake as I'm giving out points, I can go back and change that. Also notes that the display, the display you can choose if you want to see just administrators, just officers, members, combination of them all, and the idea there is that some of the groups that use us have over 300 members so it can be a lot to kind of go through and find. This way you can pick really quickly and easily.

You can also note that this is all customizable programming because every group does it a little bit differently.

So the View Entire Points Spreadsheet is to see the entire chapter. You can actually export this to Excel so you don't have to always go back and reference from the GIN System. You'll see the name, all of the events, all of the point possibilities, you'll be able to see the total points, access the user, and also the rank of that user in the total points spreadsheet.

Once those points possibilities and tabs have been created, the one thing as chapter administrator (whoever is in charge of the points system or multiple people) they can actually click on a specific event, and it shows all the members listed in that specific chapter and the those officers can click on the print sign in sheet, and actually bring the sign in sheet to an event, so when they print the sign in sheet and bring it to an event, they can actually write down how many points each person received, so when they got to their computer or mobile application they can actually then put in there how many points each person received.

As we're going through this a feature that we're also going to talk about is getting points out based upon the different section. So if I want to have a section for community service, I'll create a section for community service, and I can give the ability to give out points in this section just to the community service chair. That way whoever is in charge of the different events and whoever is in charge of community services, philanthropy, they can only give out points for those specific areas. So the nice thing is it's accountability for whoever is in charge instead of one designated points chair.

And then also we do give them the capability on that main manage points screen as administrators they can delete any points possibility or points tab. So maybe if there is something that is a few years old, since we will be archiving these points for them, they can actually delete it on there so they don't have to have all those things that are 3 years old sitting on their screen. They can actually delete those so the list isn't super long for their members.

We also do have a run auto check button. That's just in case they're saying our points aren't really looking like the correct numbers, if we click that, that may kind of run auto script to make sure that the numbers are tallied correctly.

You print this page and export it to excel. You can see the first name, last name, username, total number of points, total percentage of points, and you can even see the less than or more than points. Maybe it was cut off time, you can only see those that are more than 100 points and can attend the event or less than 100 points.

And with the point system as a whole we do need to remember just to point out that there are those separate access levels including the difference between initiated members and new members. So a lot of times chapters do things with the new members that they get points for, especially with their new member process, so that's something that we also need to recognize: members vs. new members.

Actually the “Edit Points System Settings” you can kind of set up who points are for. So maybe we don't want to new members to have a capability of seeing their points, or maybe don't want them to get points at all. We talked about points being for specific members, you can literally check off—maybe because people are on probation—and this is your ways of documenting whether if they can do anything, or if anyone in the chapter is good to go.

Points can be for anything.

This is also the screen where you pick the points to basically, it's member appeals a points, notify this member so we pick a member and the points chair to receive the automatic notifications. Also you can choose to not allow members to appeal their points after certain period of time after an event, or after creation, so that way if there's an event like, formal, you can have the appeals set so you can't appeal points 36 hours before the events.

On the event section, in the GIN System that we have, right now when you click on to a specific event on the calendar, information pops up such as if it's a one time event or recurrent event, times, date, all that information. One of the clients that we work with actually asked if we can put the amount of points on there that the specific event is worth. This way when members log on and they click on the calendar they can see how many points that event is worth so they can pick—if they have a busy class schedule that week they can pick the events that are most important to them.

And we have also thought about adding the capability that if you log in to the GIN System you get a point, or if you log in a certain many times a week you get a point, or log in from iPhone app/Android app or from any of our other mobile or Facebook apps, we know where you're coming from, and we can document those things and then leave it up to those administrators to decide when people get points for checking up on their organization.

Answering questions would give you points—anything you click on GIN you would get points. Based upon that they would automatically get it in their points section.

We've also made a mobile app where you can check in to your event from the mobile app. It's basically like a sign in sheet but its on a phone.

Let's use an event Chapter on a certain night. Maybe there's 5 points that are capable of being earned. So everyone's from 0 to 5. If I know that everyone's at chapter, I can give everyone 5 out of 5 points because I know everyone was there. You can do all of that in one swoop instead of individually giving everyone 5 points.

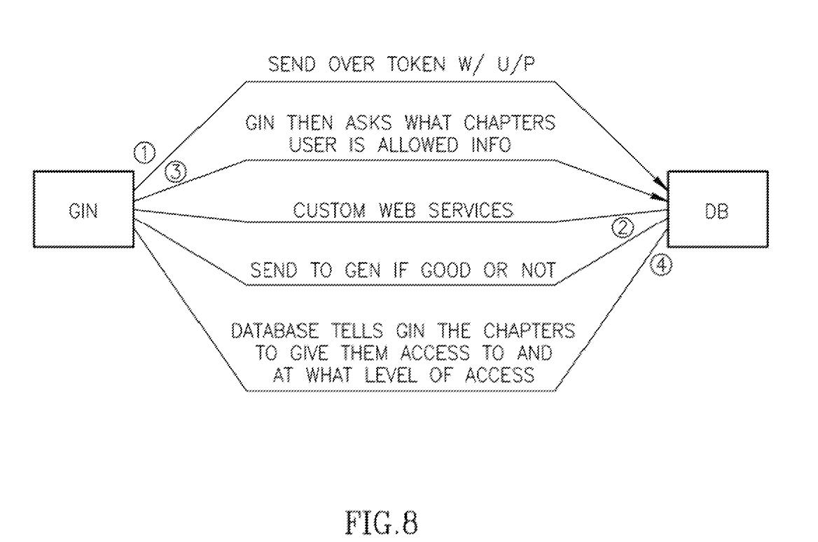

We integrate our clients' system in a unique way for a variety of reasons. We want to make sure their technologies talk together. Specifically we connect the member data like phone numbers, email addresses, home addresses, Facebook UIDs, etc. and could collect anything else and feed this information back into their national database. We do this once a day for some clients and other clients we do this in real time. Also any updates from the national database also come back to us to update our systems either once a day or in real time so from the user perspective it is all done seamlessly. The Diagram at FIG. 8 is an explanation of how we do this integration.

Here is some of the coding and technical references:

Information on how the integration works

GIN calls the validate Login method on the client's webservice gateway.

From that webservice we pass the username and password as the argument.

The data that flows back to us is a response indicating whether the credentials are correct and the contactID for the individual (we refer to this internally as Call#1).

We use this ID to call the method GetContact on the webservice gateway which would be the same webservice

When we do this GIN receives back the response containing a block of data about the user which includes ContactID, which is the affiliated chapter.

We use the ContactID to discover which GIN to guide the user into based on the GIN-ContactID mapping at our end. We provide this mapping such that iMIS ID(s) match up with which GIN System since some users can get into multiple GIN Systems.

We also get back what kind of access level they have within the database. This access level is mapped to the access levels in GIN. For example whether somebody is a member, new member, or alumnae. In the database here are multiple levels of membership but we push members into one of those categories based off of our conversation with our clients which has pretty straight forward. The only difference is whether a user is in good standing and if they can then access their GIN System from group to group.

Once users log into the GIN, they can view their profile and update their information along with interacting with a host of other features.

Here is an example of how the validateLogin call would proceed:

```
string REMOTE_URL = “client databse string”;
string SOAPACTION_URL = “via webservice”;
... prepare payload and store in sendstr
String sendstr = xmlStringpre + xdata + xmlStringpost;
...
ASCIIEncoding encoding = new ASCIIEncoding( );
  byte[ ] bytesToWrite = encoding.GetBytes(sendstr);
  HttpWebRequest request = (HttpWebRequest)
              HttpWebRequest.Create(REMOTE_URL);
  request.Method = “POST”;
  request.ContentLength = bytesToWrite.Length;
  request.Headers.Add(“SOAPAction: \”“ + SOAPACTION_URL +
  “\”“);
  request.UserAgent = “GIN proxy”;
  request.ContentType = “text/xml”;
  Stream newStream = request.GetRequestStream( );
  newStream.Write(bytesToWrite, 0, bytesToWrite.Length);
  newStream.Close( );
  HttpWebResponse response =
  (HttpWebResponse)request.GetResponse( );
  Stream dataStream = response.GetResponseStream( );
  StreamReader reader = new StreamReader(dataStream);
  string responseFromServer = reader.ReadToEnd( );
```

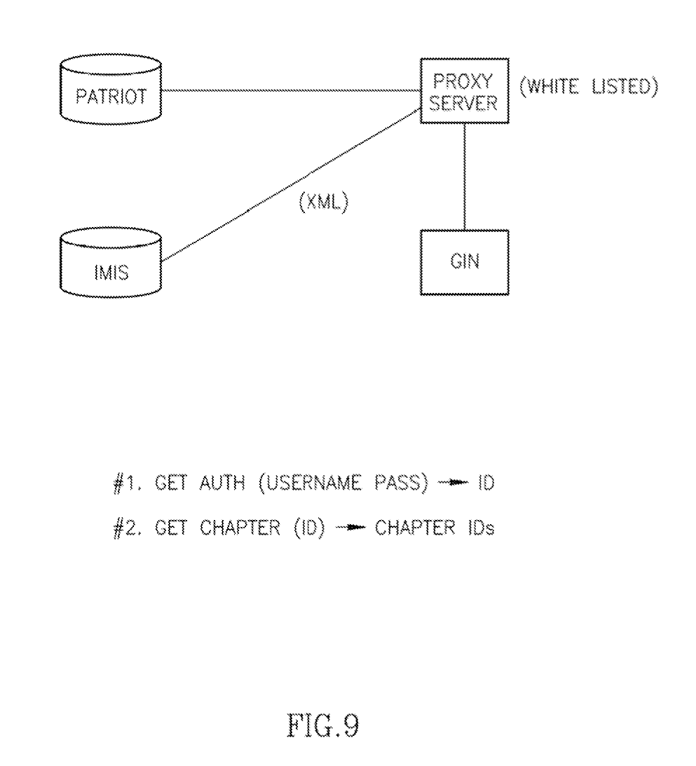

The string responseFromServer is then fed back to the GIN application, which processes the response payload and prepares for the execution of the next action. The diagram at FIG. 9 is a technical diagram of this happening.

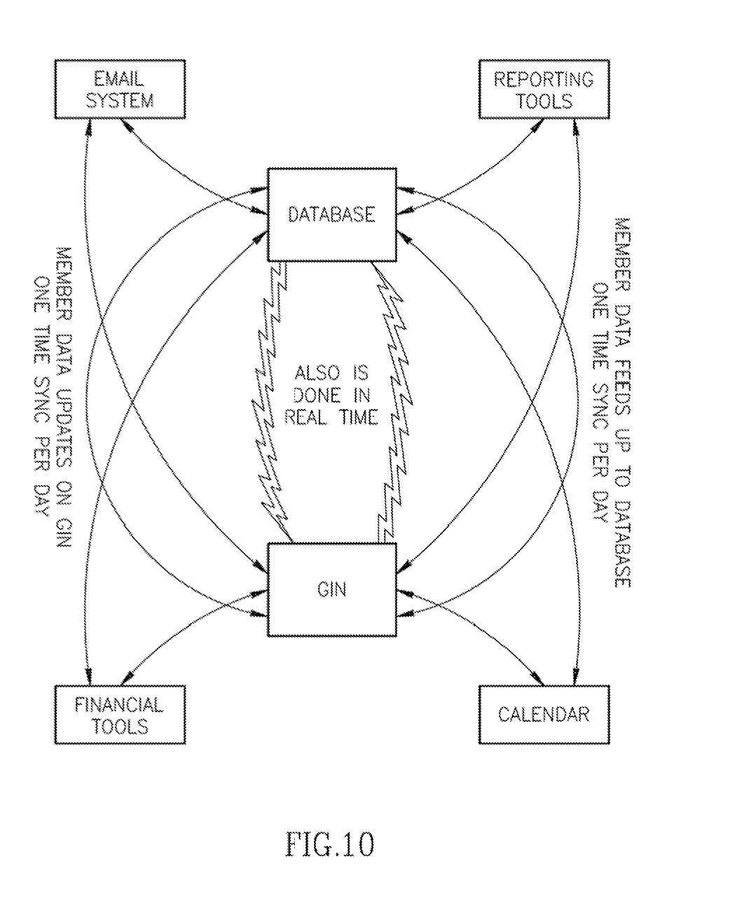

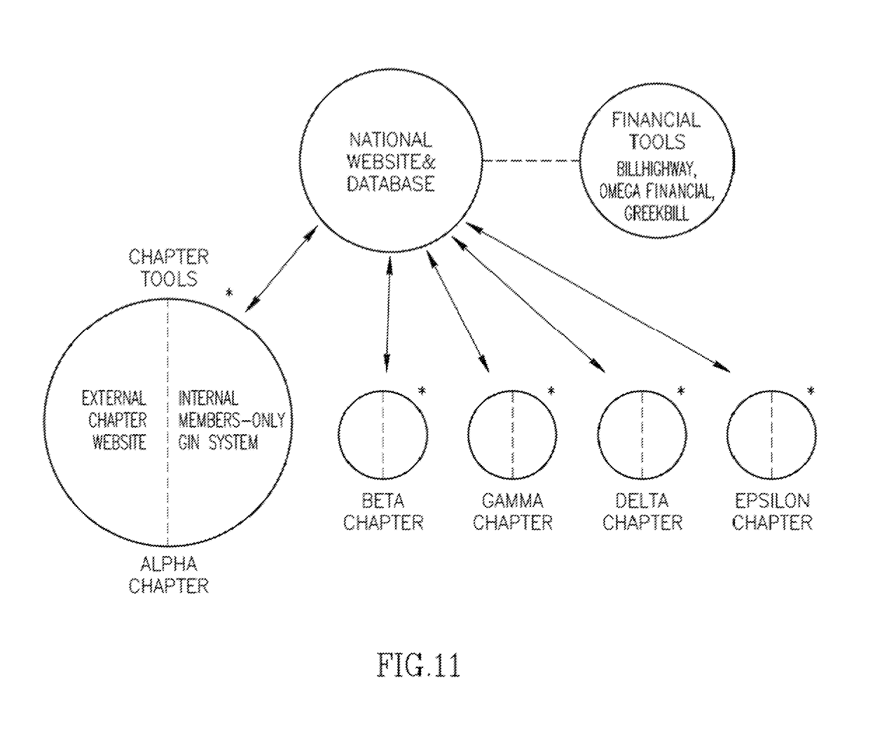

The diagram at FIG. 10 is another diagram of what we are currently working on. In this scenario everything is connected. Not only the GIN Systems and database but also the financial tools, reporting tools, the organizations calendar, and then everything with each other.

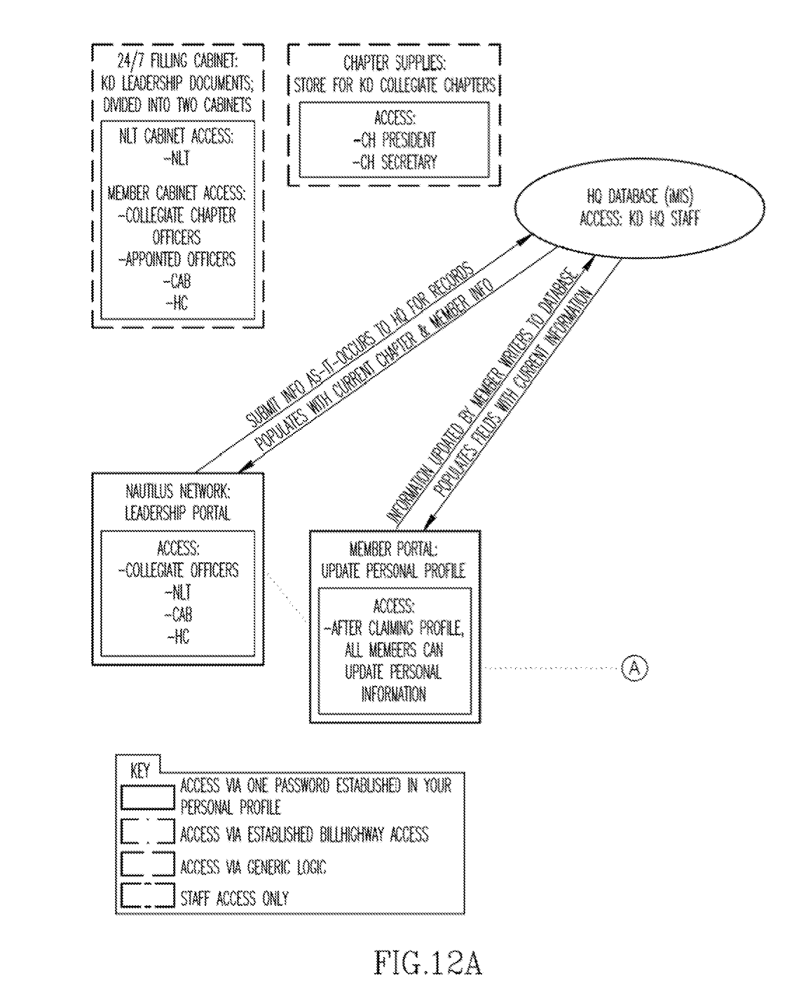

The diagram at FIG. 11 also shows these connections.

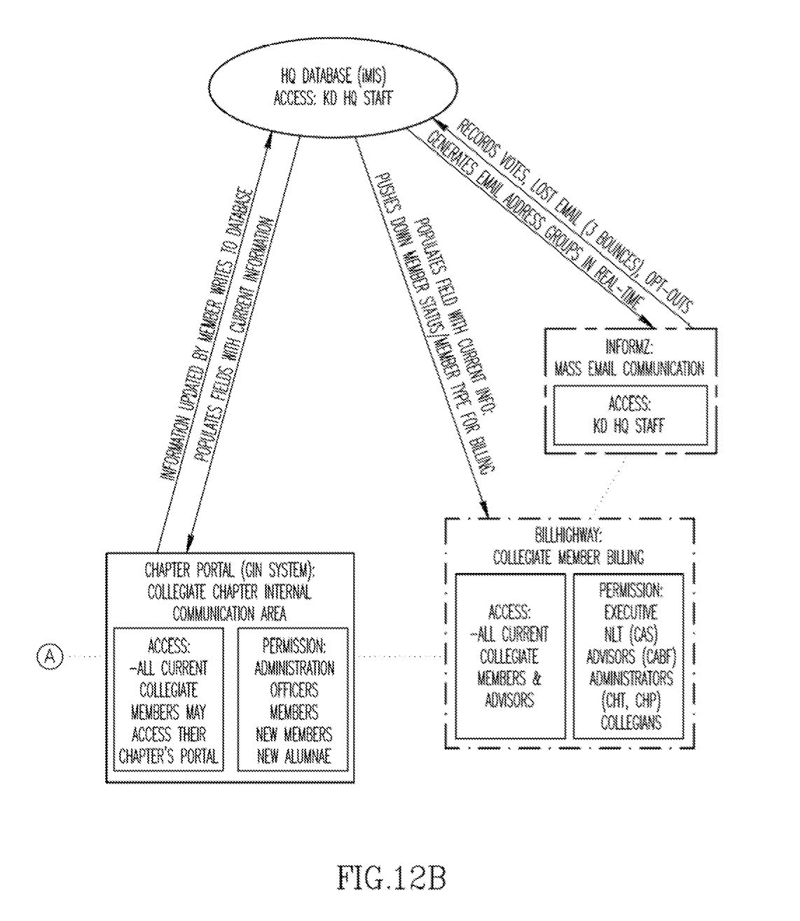

The diagram at FIG. 12 is one we provided for one of our clients.

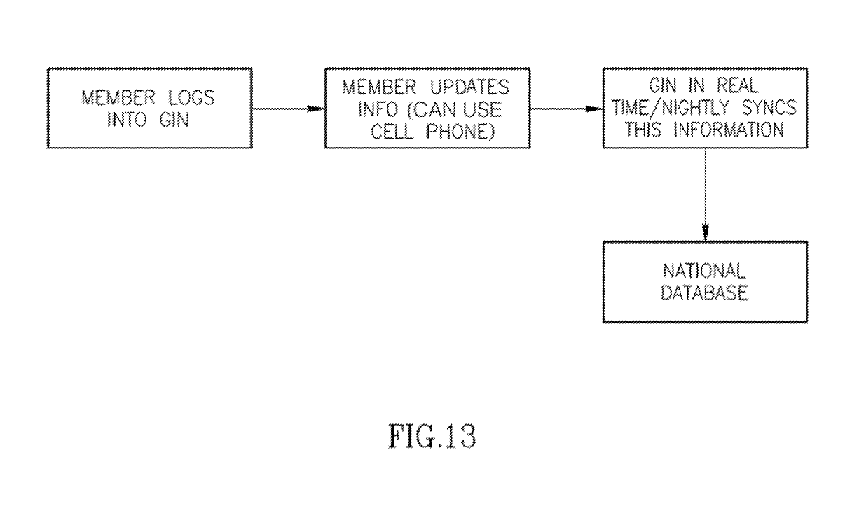

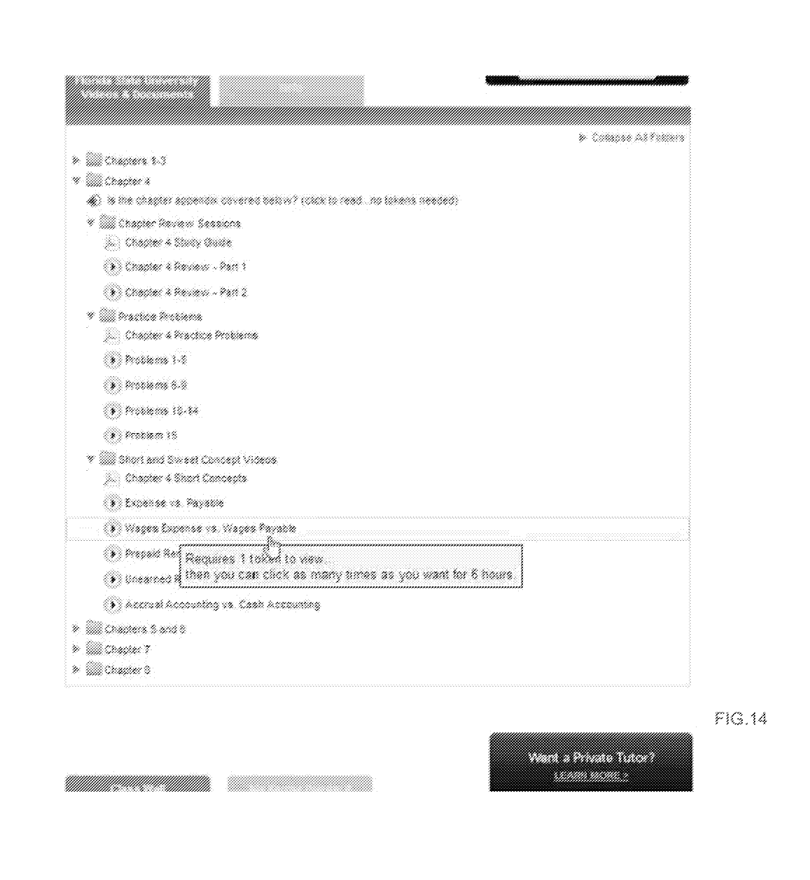

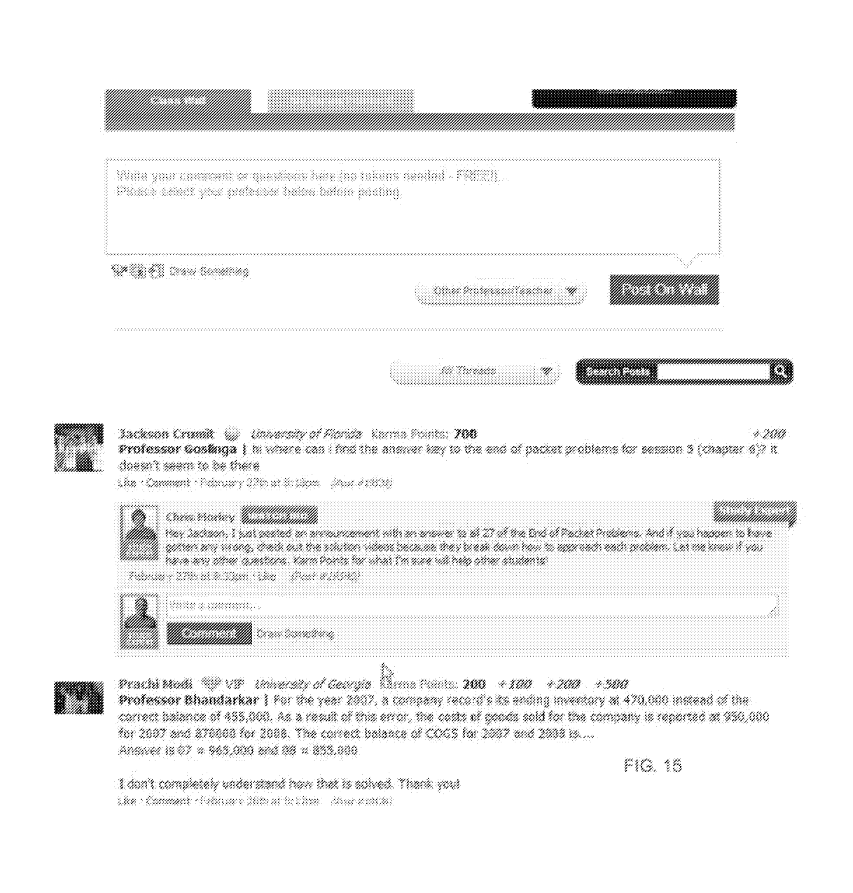

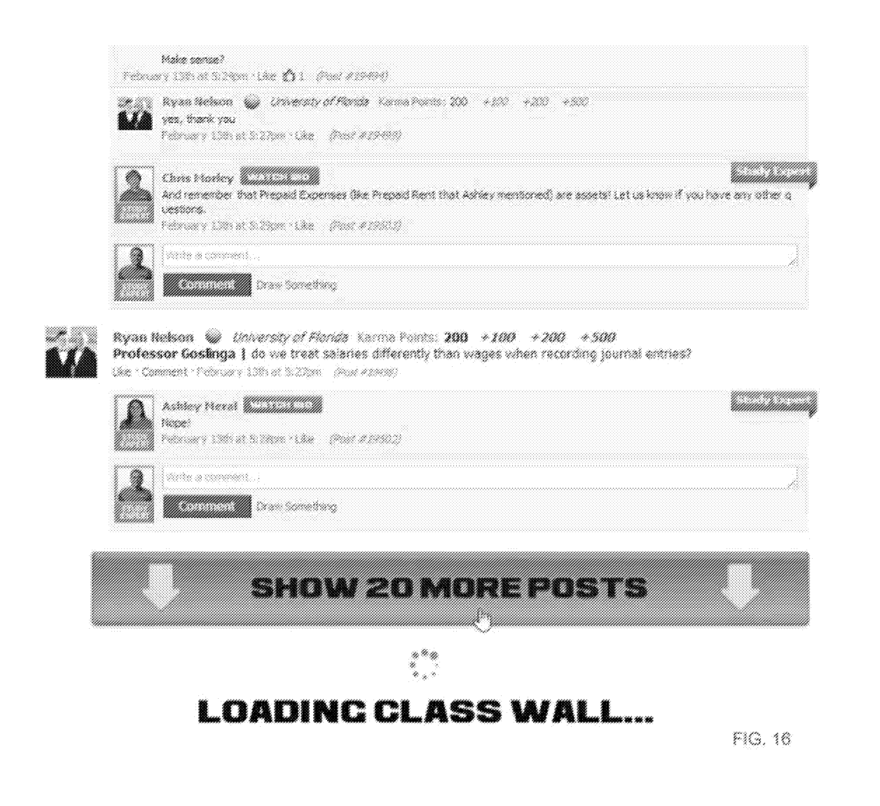

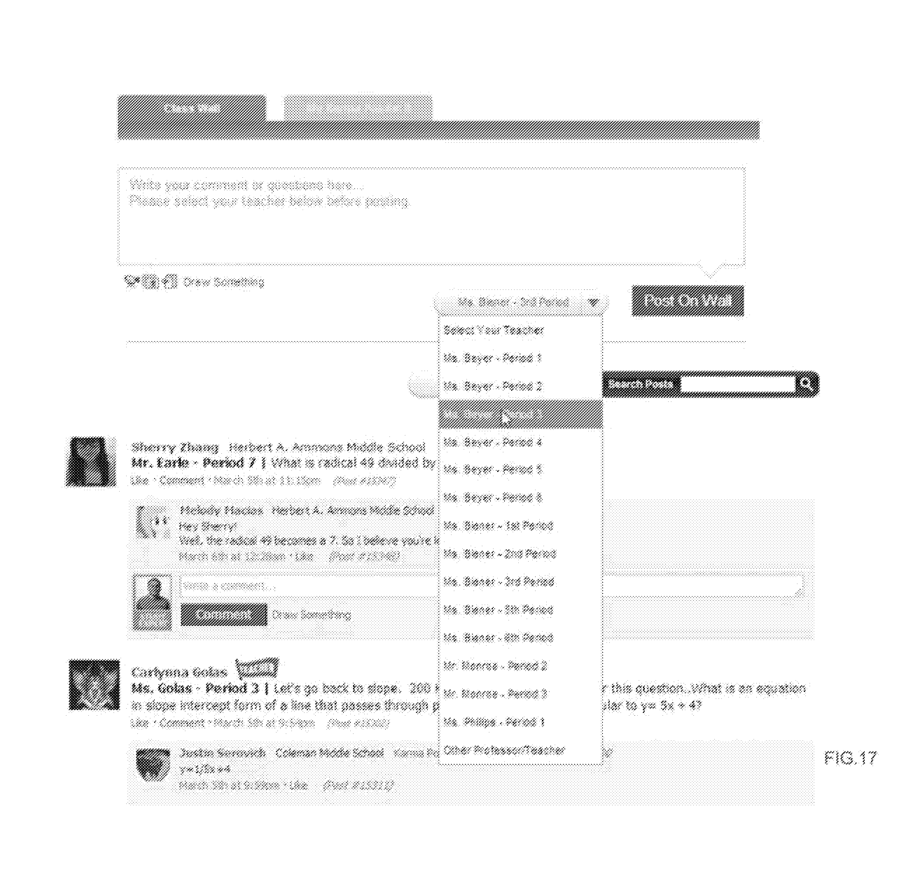

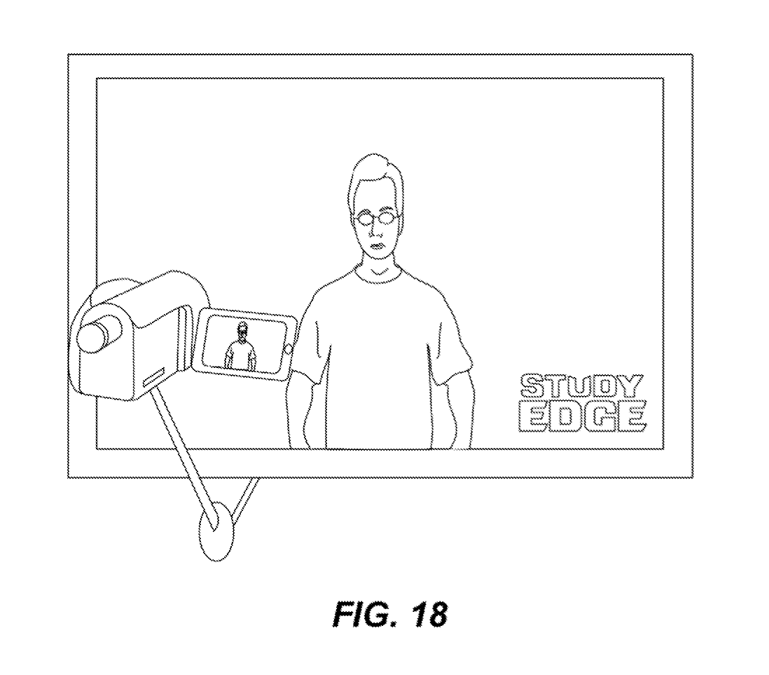

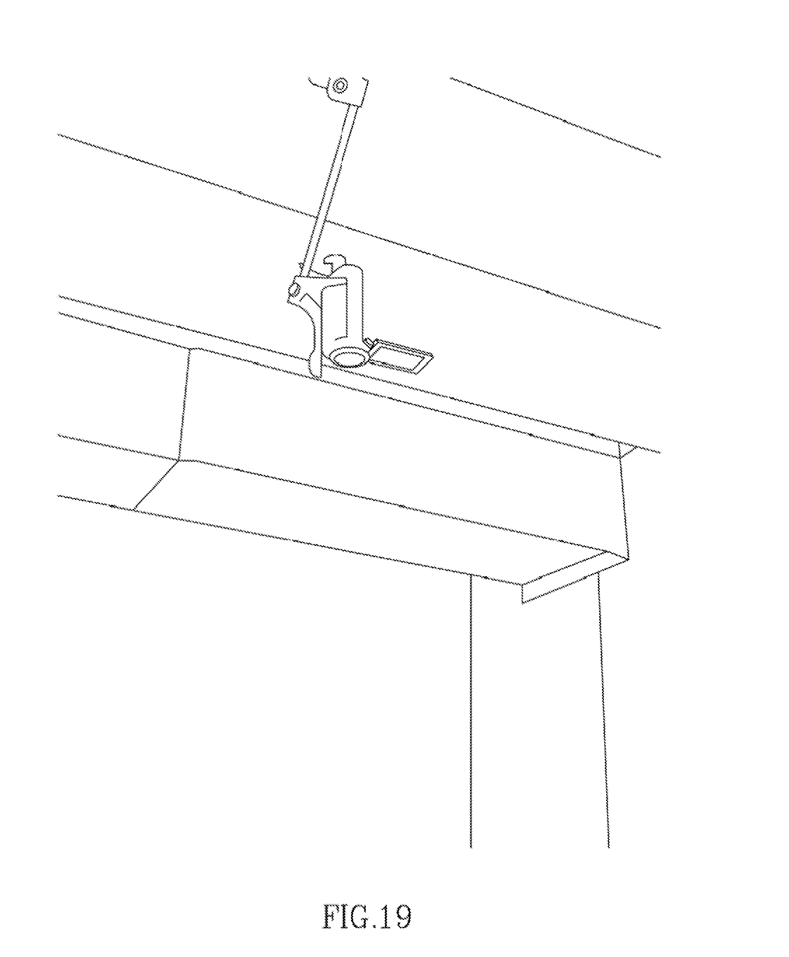

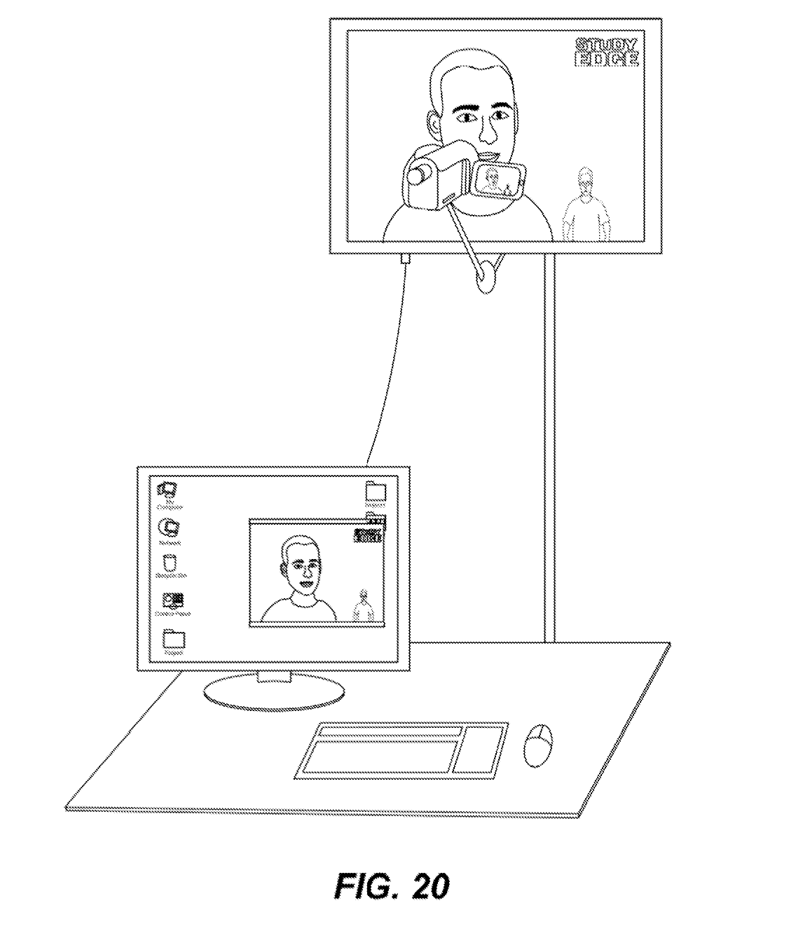

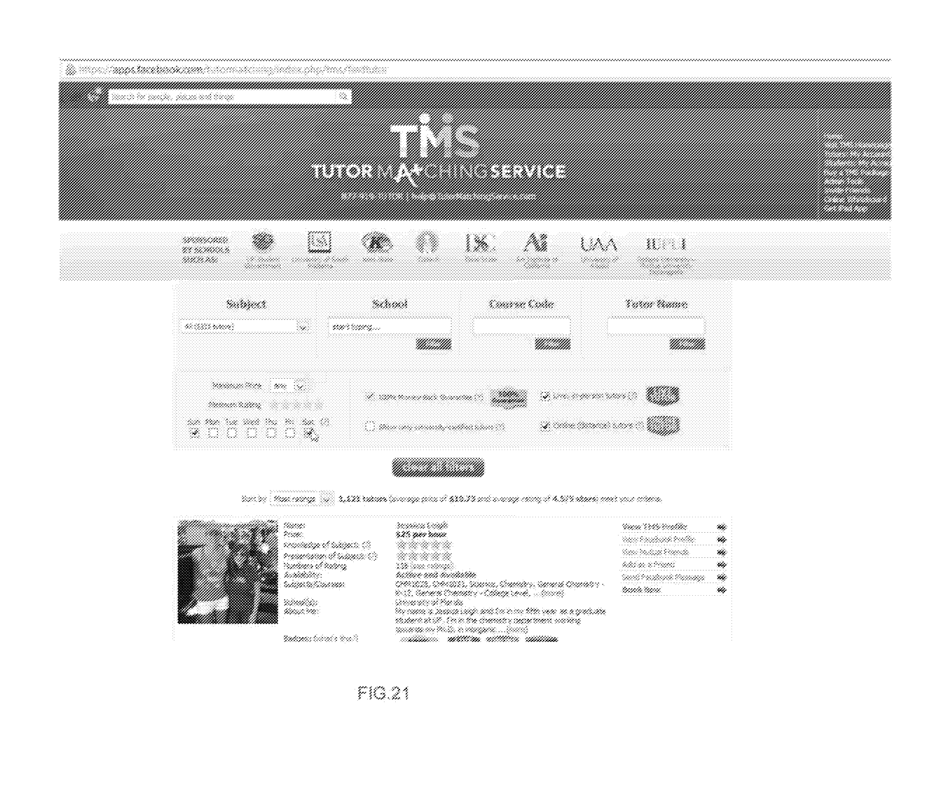

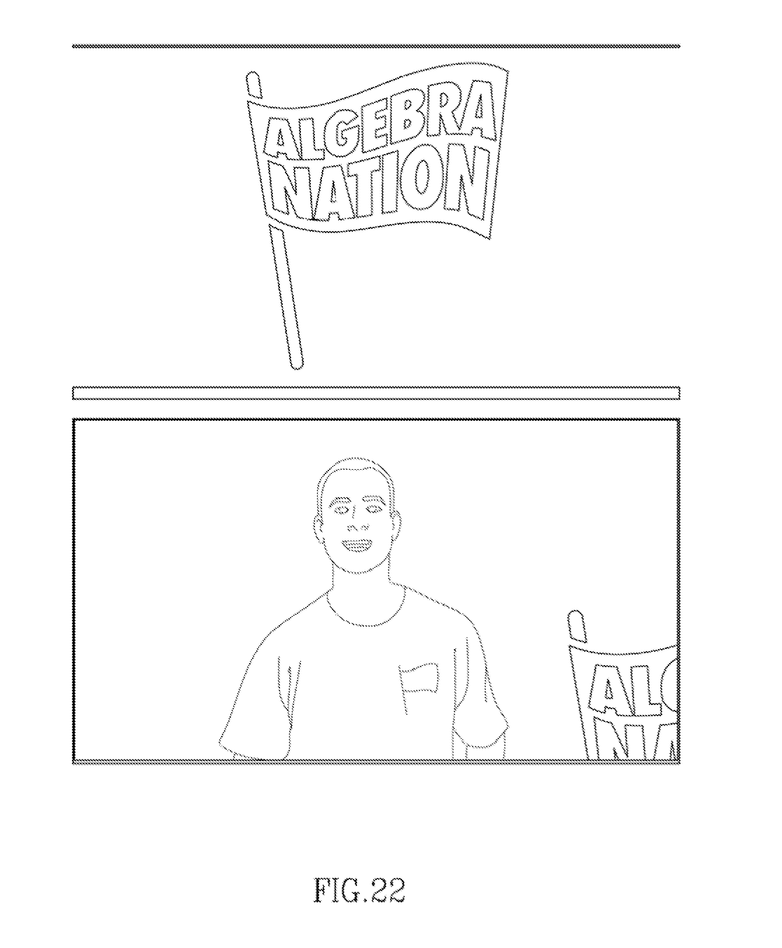

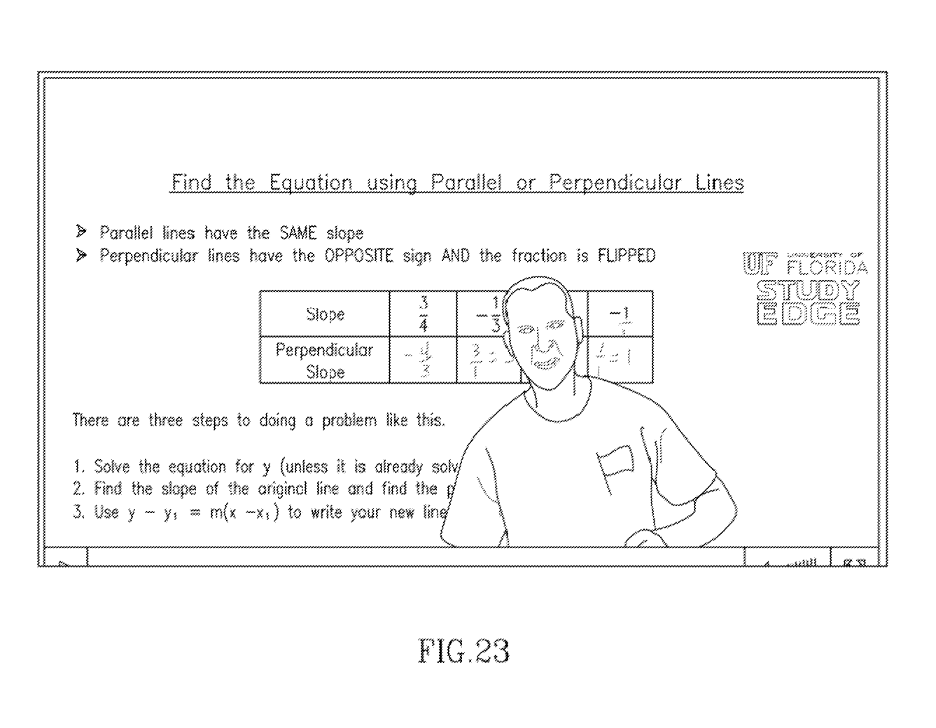

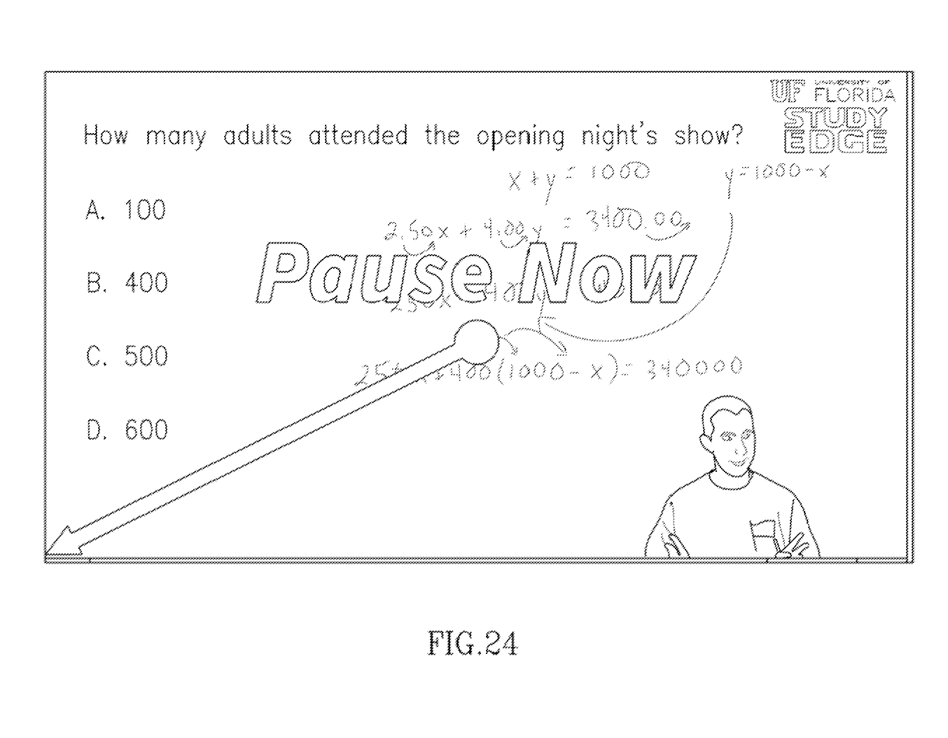

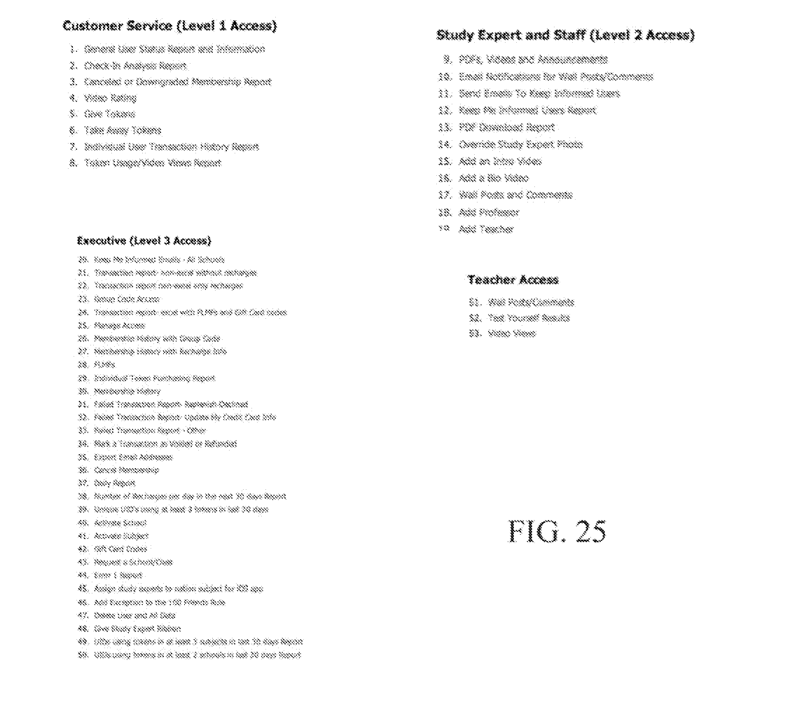

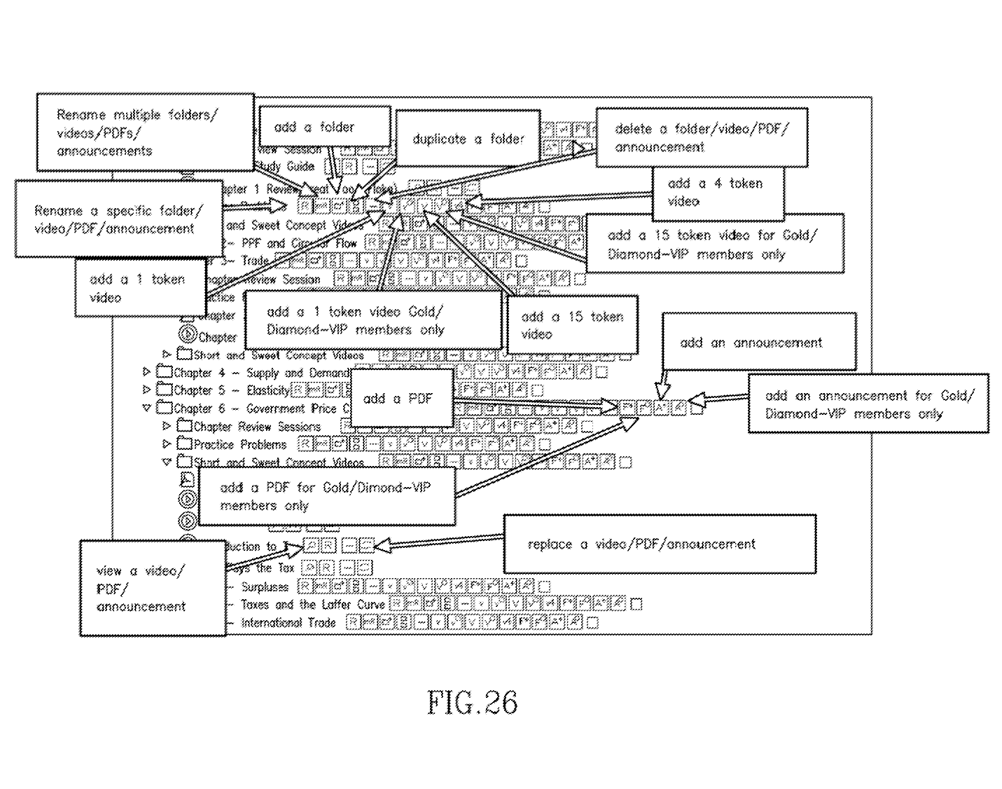

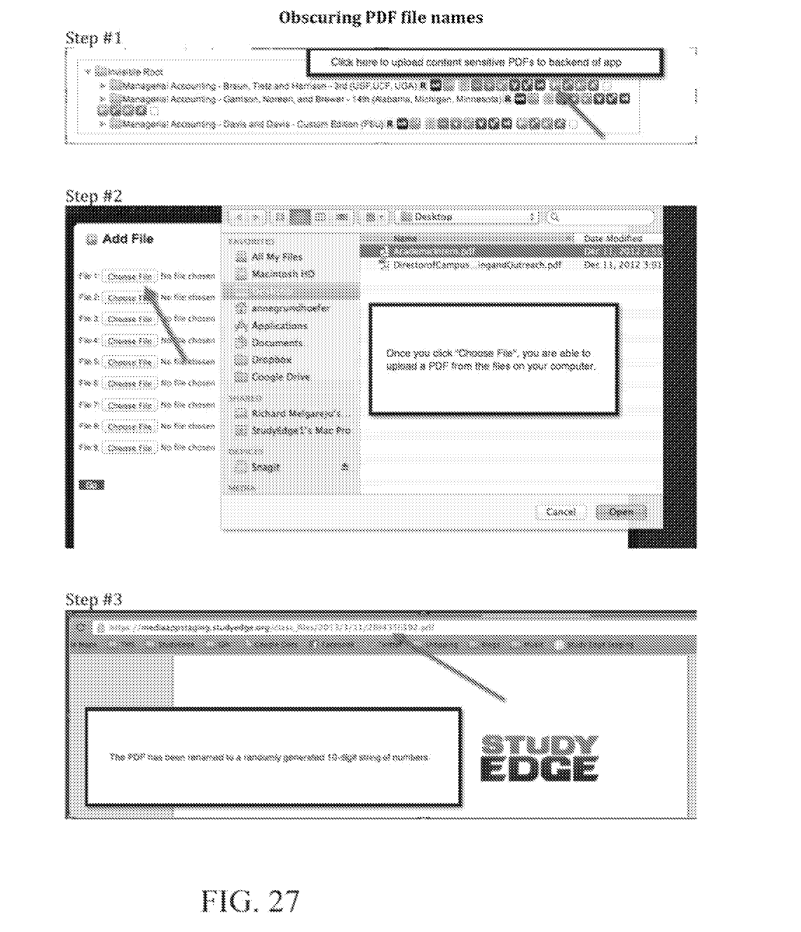

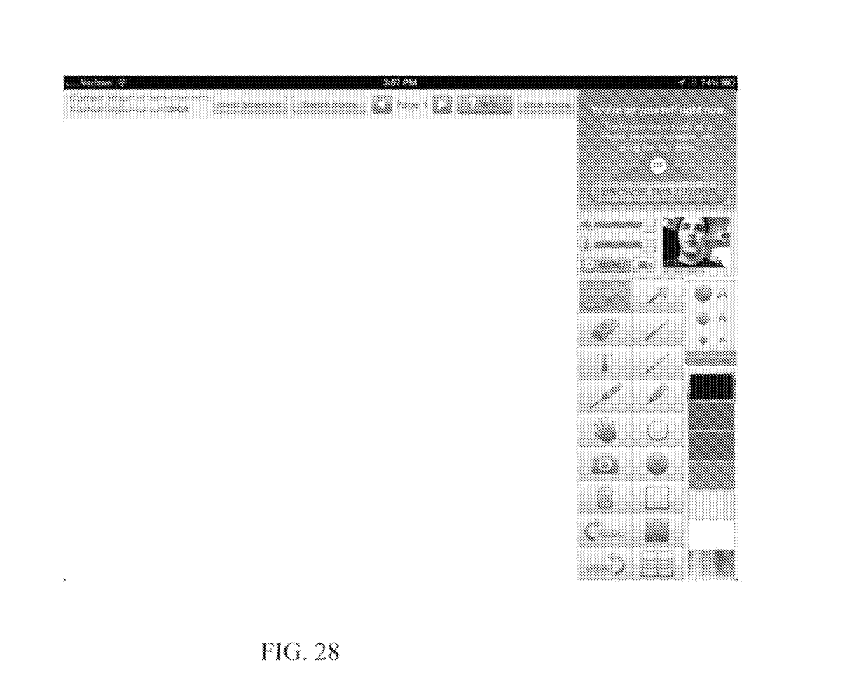

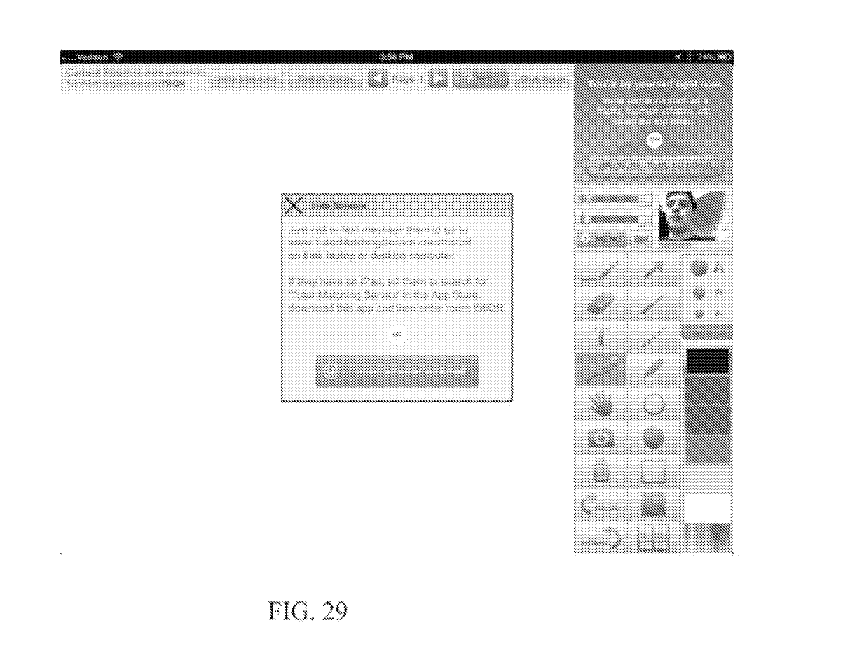

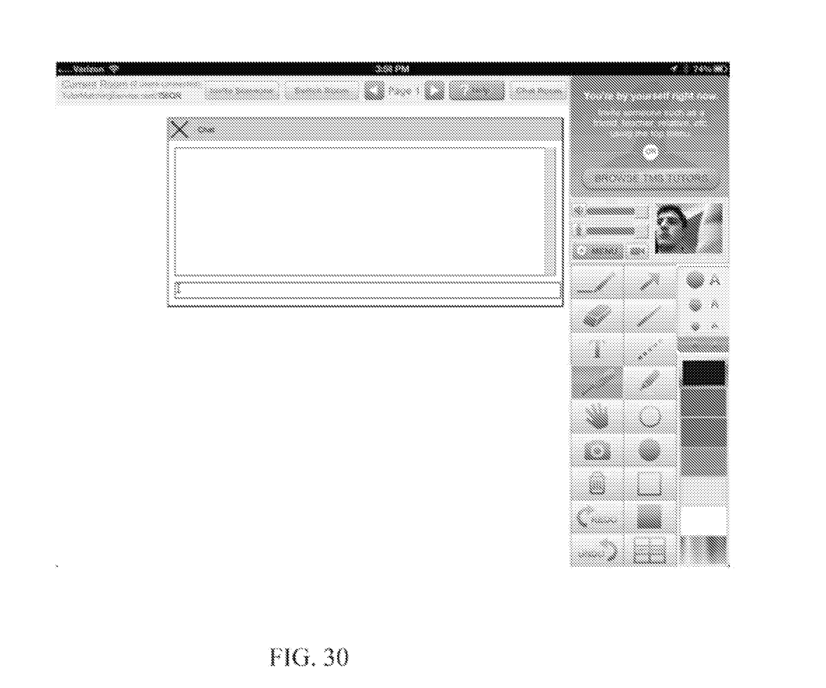

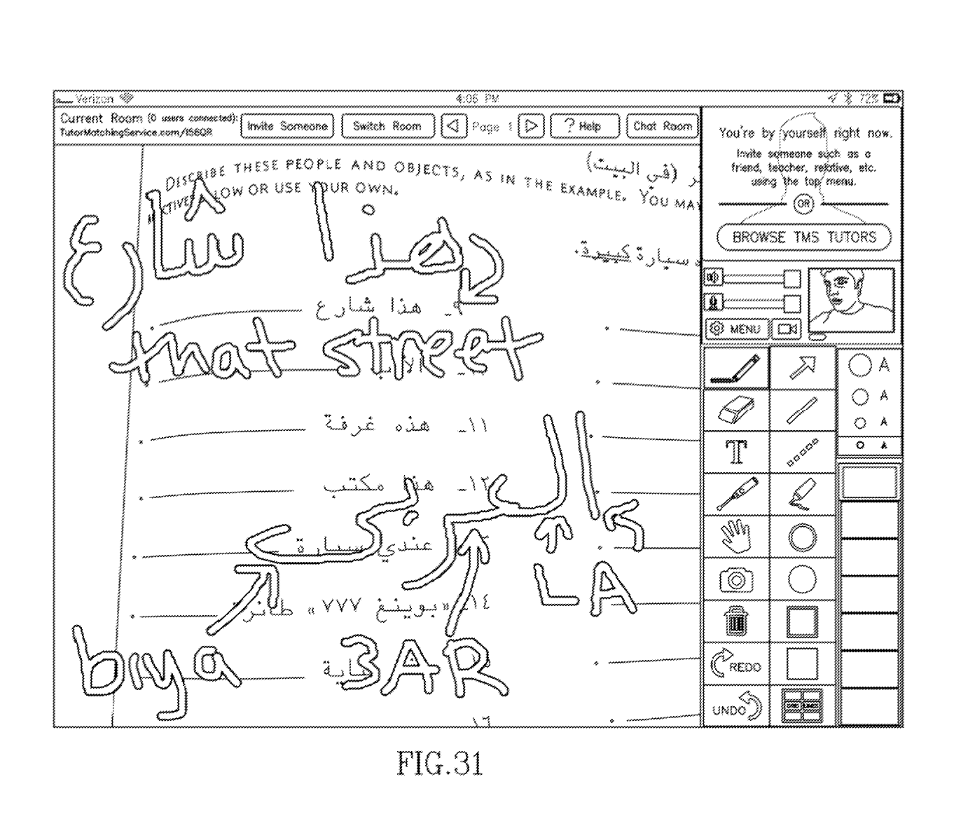

The diagram at FIG. 13 is a flow of a member updating information.

The overall idea is that chapters are not updating information on their national database but they do have a larger chance an affinity to their local groups/chapter. So we piggy back off of that and get the information to the national organization for fundraising purposes.

This information could easily be turned into an API that could be shared with advertising networks or could also be shared with groups.

Integration has made client's jobs easier and overall has increased their data they have users especially after users graduate.

While the preferred embodiment of the invention has been illustrated and described, as noted above, many changes can be made without departing from the spirit and scope of the invention. In addition, other advantages will also be apparent to those of skill in the art with respect to any of the above-described embodiments whether viewed individually or in some combination thereof. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for matching instructors and students, the method comprising:
generating a database of instructors from one or more learning institutions;
determining whether an instructor is friends with or has mutual friends with a student;
providing a personality test to the student to determine a learning type of the student; and
permitting the student to select an instructor.

2. The method of claim 1, further comprising providing at least one name of the instructor before the student takes the personality test.

3. The method of claim 1, wherein determining whether the instructor is friends with or has mutual friends with the student includes not sending a message to the student if no friends or no mutual friends are found.

4. The method of claim 1, wherein determining whether the instructor is friends with or has mutual friends with the student includes checking a social media site that the student and the instructor have in common.

5. The method of claim 4, wherein the providing the personality test to the student includes providing a quasi-Meyers-Briggs personality test.

6. The method of claim 1, wherein determining the learning type of the student includes determining whether the student learns better from examples first or from concepts first.

7. The method of claim 1, further comprising providing additional criteria to assist the student in selecting the instructor.

8. The method of claim 7, wherein the additional criteria includes an instructor rank or score.

9. The method of claim 7, wherein the additional criteria includes a number of teaching hours that have been completed by the instructor.

10. The method of claim 7, wherein the additional criteria includes a certification of the instructor.

11. A method for instructor certification from a learning institution, the method comprising:
receiving a request for a new certification from an instructor;
evaluating the request for the new certification; and
determining whether the request should be accepted or rejected.

12. The method of claim 11, wherein determining that the request should be rejected includes providing feedback to the instructor as to how to achieve the requested certification.

13. A method for instructor certification from a learning institution, the method comprising:
receiving a request for a certification from an instructor, wherein the instructor believes that the instructor is pre-certified;
verifying the request for the certification; and
determining whether the request should be accepted or rejected.

14. The method of claim 13, wherein determining that the request should be rejected includes providing feedback to the instructor as to how to achieve the requested certification.

15. A method for viewing an online learning session, the method comprising:
commencing an online learning session in which an instructor is initially viewable by the students through a face camera;
toggling a viewing format of the online learning session to a picture-in-picture (PIP) viewing format; and
depending on subject being taught by the instructor, selectively toggling the viewing format between the PIP viewing format, the face camera viewing format, and a document camera viewing format.

16. The method of claim 15, wherein toggling the viewing format is initiated by the instructor.

17. The method of claim 15, wherein toggling the viewing format is initiated by the student.

18. The method of claim 15, further comprising showing an animation in the viewing format to teach or stress an important topic or an important teaching point.
